(19) United States
(12) Patent Application Publication
(10) Pub. No.: US 2025/0076553 A1
(43) Pub. Date: Mar. 6, 2025

(54) OPTICAL ELEMENT

(71) Applicant: Sharp Display Technology Corporation, Kameyama City (JP)

(72) Inventors: Ryosuke SAIGUSA, Kameyama City (JP); Akira SAKAI, Kameyama City (JP); Yuichi KAWAHIRA, Kameyama City (JP)

(21) Appl. No.: 18/770,711

(22) Filed: Jul. 12, 2024

(30) Foreign Application Priority Data
Aug. 31, 2023 (JP) 2023-141490

(51) Int. Cl. G02B 5/30

(52) U.S. Cl. CPC G02B 5/3016

(57) ABSTRACT

Provided is an optical element that can achieve favorable optical characteristics. The optical element of the present invention includes, in the following order: a first alignment film; a first optically anisotropic layer containing a first anisotropic molecules; a second alignment film; and a second optically anisotropic layer containing a second anisotropic molecules.

### CROSS-REFERENCE TO RELATED APPLICATIONS

The present application claims priority under 35 U.S.C. § 119 to Japanese Patent Application No. 2023-141490 filed on Aug. 31, 2023, the contents of which are incorporated herein by reference in their entirety.

### BACKGROUND OF THE INVENTION

### Field of the Invention

The present disclosure relates to optical elements.

### Description of Related Art

There have been suggestions to use an optical system including an optical element such as a Pancharatnam-Berry phase optical element (PBOE) in a head-mounted display or other display devices. A PBOE includes, for example, an optically anisotropic layer formed from a liquid crystal composition containing liquid crystal molecules. A PBOE is also referred to as a PB lens.

JP 2008-532085 T discloses as a PBOE a polarization grating including a polarization sensitive photo-alignment layer (2) and a liquid crystal composition (3) arranged on said alignment layer (2), wherein an anisotropic alignment pattern corresponding to a polarization hologram is arranged in said photo-alignment layer and said liquid crystal composition (3) is aligned by said alignment pattern.

### BRIEF SUMMARY OF THE INVENTION

FIG. 45 is a schematic cross-sectional view showing the structure of a common PB lens. As shown in FIG. 45, a common PB lens 10R includes a supporting substrate 100R, an alignment film 200R, and an optically anisotropic layer 300R, which is a λ/2 plate, in the stated order. The diffraction efficiency of the PB lens 10R reaches its maximum when the phase difference provided by the PB lens 10R is half a wavelength. Thus, in order to achieve broadband diffraction efficiency, a broadband half-wave plate is required.

The PB lens 10R is obtained by, for example, subjecting the alignment film 200R on the supporting substrate 100R to alignment treatment through mask exposure, and aligning anisotropic molecules (e.g., reactive mesogens (also referred to as RMs)) on the alignment film 200R having been subjected to the alignment treatment to form the optically anisotropic layer 300R. The optically anisotropic layer 300R is also referred to as an RM layer. The existing RM layers exhibit a non-ideal wavelength dispersion, making it difficult to achieve broadband favorable diffraction efficiency even when a λ/2 A-plate is produced.

Also, in a PB lens, RMs are disposed to rotate in the plane. In the case of producing a PB lens through multiple mask exposures, the mask is required to have an alignment accuracy on the order of the frequency of the RM molecular rotation period. The shorter the focal length of the PB lens, the shorter the molecular rotation period, which makes the production more difficult.

Meanwhile, J P 2008-532085 T does not disclose any technique of achieving favorable optical characteristics, such as broader band favorable diffraction efficiency and/or a shorter focal length.

In response to the above issues, an object of the present invention is to provide an optical element that can achieve favorable optical characteristics.

(1) One embodiment of the present invention is directed to an optical element including, in the following order: a first alignment film; a first optically anisotropic layer containing first anisotropic molecules; a second alignment film; and a second optically anisotropic layer containing second anisotropic molecules.

(2) In an embodiment of the present invention, the optical element includes the structure (1), and further includes: a third alignment film disposed on a surface of the second optically anisotropic layer opposite to the second alignment film; and a third optically anisotropic layer disposed on a surface of the third alignment film opposite to the second optically anisotropic layer and containing third anisotropic molecules.

(3) In an embodiment of the present invention, the optical element includes the structure (2), and with an azimuthal angle of a slow axis of the first optically anisotropic layer being set at 0°, an azimuthal angle of a slow axis of the second optically anisotropic layer is greater than 35° and smaller than 50°, and an azimuthal angle of a slow axis of the third optically anisotropic layer is greater than −25° and smaller than 25°.

(4) In an embodiment of the present invention, the optical element includes the structure (3), a phase difference of the first optically anisotropic layer provided to light with a wavelength of 550 nm is 120 nm or more and 150 nm or less, a phase difference of the second optically anisotropic layer provided to light with a wavelength of 550 nm is 150 nm or more and 350 nm or less, and a phase difference of the third optically anisotropic layer provided to light with a wavelength of 550 nm is 120 nm or more and 150 nm or less.

(5) In an embodiment of the present invention, the optical element includes the structure (2), and with an azimuthal angle of a slow axis of the first optically anisotropic layer being set at 0°, an azimuthal angle of a slow axis of the second optically anisotropic layer is greater than 35° and smaller than 50°, and an azimuthal angle of a slow axis of the third optically anisotropic layer is greater than −5° and smaller than 5°.

(6) In an embodiment of the present invention, the optical element includes the structure (5), a phase difference of the first optically anisotropic layer provided to light with a wavelength of 550 nm is 120 nm or more and 150 nm or less, a phase difference of the second optically anisotropic layer provided to light with a wavelength of 550 nm is 210 nm or more and 290 nm or less, and a phase difference of the third optically anisotropic layer provided to light with a wavelength of 550 nm is 120 nm or more and 150 nm or less.

(7) In an embodiment of the present invention, the optical element includes the structure (1), and in a plan view, alignment directions of the first anisotropic molecules and alignment directions of the second anisotropic molecules each rotate in a plane from a central portion to an end portion of the optical element, and a rotation direction of the first anisotropic molecules is opposite to a rotation direction of the second anisotropic molecules.

(8) In an embodiment of the present invention, the optical element includes the structure (7), and satisfies the following Formula A:

$$Molecular alignment [ ° ] < 90 / ( Wavelength [ m ] ) / ( Focal length [ m ] ) * {( Distance from center of lens [ m ] )}^{2} \qquad ( Formula A )$$

where the molecular alignment represents an azimuthal angle of a molecular alignment of each of the first anisotropic molecules or each of the second anisotropic molecules; the wavelength represents a wavelength of incident light; the focal length represents a focal length of the optical element; and the distance from a center of a lens represents a distance from a center of the optical element to the first anisotropic molecule or the second anisotropic molecule.

(9) In an embodiment of the present invention, the optical element includes the structure (1), (2), (3), (4), (5), (6), (7), or (8), and from a central portion toward an end portion of the optical element, the first anisotropic molecule and the second anisotropic molecule each have a discrete molecular alignment pattern.

The present invention can provide an optical element that can achieve favorable optical characteristics.

### BRIEF DESCRIPTION OF THE DRAWINGS

FIG. 1 is a schematic cross-sectional view of an optical element of Embodiment 1.

FIG. 2 is a schematic view of a first exposure step in a method of producing the optical element of Embodiment 1.

FIG. 3 is a schematic view of a second exposure step in the method of producing the optical element of Embodiment 1.

FIG. 4 is a schematic view of a state after the first exposure step and the second exposure step in the method of producing the optical element of Embodiment 1.

FIG. 5 is a schematic plan view of an example of a mask set for use in production of the optical element of Embodiment 1.

FIG. 6 is a schematic plan view of an example of a common mask set.

FIG. 7 is a schematic cross-sectional view of an optical element of Embodiment 2.

FIG. 8 is a schematic cross-sectional view of an optical element of Embodiment 3.

FIG. 9 shows the molecular alignments of anisotropic molecules superimposed on micrographs of a first optically anisotropic layer and a second optically anisotropic layer in the optical element of Embodiment 3.

FIG. 10 is a schematic view illustrating the case of producing a PB lens through multiple mask exposures.

FIG. 11 is a schematic view showing a specific example of the case of producing a PB lens through multiple mask exposures.

FIG. 12 is a view illustrating the case where molecular rotation directions of two PB lenses are the same.

FIG. 13 is a view illustrating the case where molecular rotation directions of two PB lenses are opposite.

FIG. 14 is a graph showing a phase difference of a half-wave plate in Comparative Example 1.

FIG. 15 is a graph showing the calculated diffraction efficiency values of the half-wave plate in Comparative Example 1.

FIG. 16 is a schematic cross-sectional view illustrating an alignment film formation step included in a step of producing a PB lens of Reference Example 1.

FIG. 17 is a schematic cross-sectional view illustrating an alignment film exposure step included in the step of producing the PB lens of Reference Example 1.

FIG. 18 is a schematic view showing a mask used to apply polarized UV with a polarization axis at 0° in the alignment film exposure step included in the step of producing the PB lens of Reference Example 1.

FIG. 19 is a schematic view showing a mask used to apply polarized UV with a polarization axis at 45° in the alignment film exposure step included in the step of producing the PB lens of Reference Example 1.

FIG. 20 is a schematic view showing a mask used to apply polarized UV with a polarization axis at 90° in the alignment film exposure step included in the step of producing the PB lens of Reference Example 1.

FIG. 21 is a schematic view showing a mask used to apply polarized UV with a polarization axis at 135° in the alignment film exposure step included in the step of producing the PB lens of Reference Example 1.

FIG. 22 is a schematic cross-sectional view illustrating an optically anisotropic layer formation step included in the step of producing the PB lens of Reference Example 1.

FIG. 23 is a micrograph of the PB lens of Reference Example 1.

FIG. 24 is a schematic view showing a focal length measurement method.

FIG. 25 shows a micrograph of the PB lens of Reference Example 1 and a graph showing the relationship between the molecular alignment and the distance from the center of the lens.

FIG. 26 is a schematic view showing a specific example of the case of producing a PB lens through multiple mask exposures.

FIG. 27 is a graph showing the calculated diffraction efficiency values of a PB lens of Comparative Example 1 and the measured diffraction efficiency values of the PB lens of Reference Example 1.

FIG. 28 is a schematic cross-sectional view of an optical element of Example 1.

FIG. 29 is a view showing on the Poincare sphere the polarization state of light having passed through a circular polarizer in the optical element of Example 1.

FIG. 30 is a view showing on the Poincare sphere the polarization state of light having passed through a first phase difference plate in the optical element of Example 1.

FIG. 31 is a view showing on the Poincare sphere the polarization state of light having passed through a second phase difference plate in the optical element of Example 1.

FIG. 32 is a view showing on the Poincare sphere the polarization state of light having passed through a third phase difference plate in the optical element of Example 1.

FIG. 33 is a view showing Formula 4 obtained using the optical element of Example 1.

FIG. 34 is a view showing Formula 5 obtained using the optical element of Example 1.

FIG. 35 is a schematic cross-sectional view of a structure in the case where in the optical element of Example 1, the phase differences of the first optically anisotropic layer and the third optically anisotropic layer are set to 150 nm.

FIG. 36 is a view illustrating the method of calculating diffraction efficiency.

FIG. 37 is a graph showing S3(x) of transmitted light versus wavelength of circularly polarized light with S3=+1 incident on the optical element of Example 1.

FIG. 38 is a graph showing diffraction efficiency versus wavelength of circularly polarized light with S3=+1 incident on the optical element of Example 1.

FIG. 39 is a schematic cross-sectional view of an optical element of Example 2.

FIG. 40 is a schematic cross-sectional view of an optical element of Example 3.

FIG. 41 is a schematic cross-sectional view of an optical element of Example 4.

FIG. 42 is a schematic cross-sectional view of an optical element of Example 5.

FIG. 43 is a schematic cross-sectional view of an optical element of Example 6.

FIG. 44 is a graph showing the relationship between the distance from the center of a lens and the molecular alignment in the optical element of Example 7.

FIG. 45 is a schematic cross-sectional view showing the structure of a common PB lens.

### DETAILED DESCRIPTION OF THE INVENTION

Hereinafter, embodiments of the present invention are described. The present invention is not limited to the contents of the following embodiments. The design may be modified as appropriate within the range satisfying the configuration of the present invention. In the following description, components having the same or similar functions in different drawings are commonly provided with the same reference sign so as to appropriately avoid repetition of description. The structures in the present invention may be combined as appropriate without departing from the gist of the present invention.

### Embodiment 1

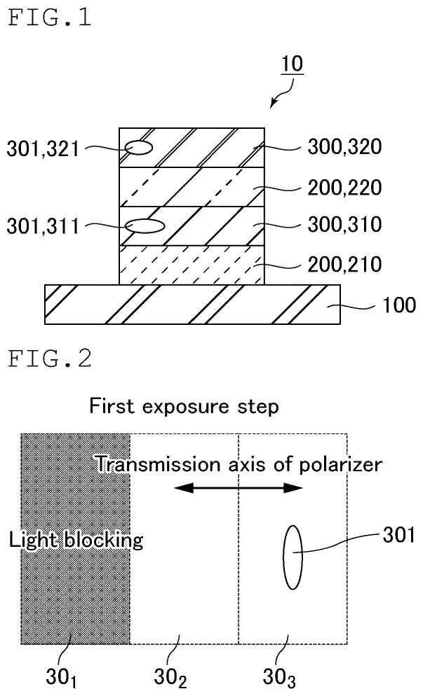

FIG. 1 is a schematic cross-sectional view of an optical element of Embodiment 1. As shown in FIG. 1, an optical element 10 of the present embodiment includes, in the following order: a first alignment film 210; a first optically anisotropic layer 310 containing first anisotropic molecules 311; a second alignment film 220; and a second optically anisotropic layer 320 containing second anisotropic molecules 321. This structure enables favorable optical characteristics. The anisotropic molecules are, for example, reactive mesogens (also referred to as RMs).

JP 2008-532085 T discloses a polarization grating in which multiple optically anisotropic layers containing RMs are laminated. Specifically, it discloses that a second liquid crystal composition 13 (RM) is arranged on and aligned by the first liquid crystal composition 3 (RM). In other words, the second liquid crystal composition 13 is aligned by the alignment regulating force of the first liquid crystal composition 3. The polarization grating therefore has low design flexibility, with which it is difficult to achieve favorable optical characteristics.

In contrast, owing to the second alignment film 220 between the first optically anisotropic layer 310 and the second optically anisotropic layer 320, the optical element 10 of the present embodiment can use the alignment regulating force of the second alignment film 220 to align the second anisotropic molecules 321 in the second optically anisotropic layer 320. As a result, the design flexibility of the optical element 10 can be made high, so that the optical element 10 can achieve favorable optical characteristics.

The optical element 10 of the present embodiment includes, in the following order: a supporting substrate 100; the first alignment film 210; the first optically anisotropic layer 310; the second alignment film 220; and the second optically anisotropic layer 320. The optical element 10 of the present embodiment is a Pancharatnam-Berry phase optical element (PBOE). A PBOE is also referred to as a PB lens. A PB lens is a liquid crystal diffractive lens which has the lens effect on incident circularly polarized light. Hereinbelow, the optical element of the present embodiment is described in detail.

Examples of the supporting substrate 100 include substrates such as glass substrates and plastic substrates. Examples of the material for the glass substrates include glass such as float glass and soda-lime glass. Examples of the material for the plastic substrates include plastics such as polyethylene terephthalate, polybutylene terephthalate, polyethersulfone, polycarbonate, and alicyclic polyolefin.

The first alignment film 210 has a function of controlling the alignment of the first anisotropic molecules 311 in the first optically anisotropic layer 310. The second alignment film 220 has a function of controlling the alignment of the second anisotropic molecules 321 in the second optically anisotropic layer 320. The first alignment film 210 and the second alignment film 220 are also simply referred to as “alignment film 200”. The first optically anisotropic layer 310 and the second optically anisotropic layer 320 are also simply referred to as “optically anisotropic layer 300”. An optically anisotropic layer 300 is also referred to as “RM layer”. The first anisotropic molecules 311 and the second anisotropic molecules 321 are also simply referred to as “anisotropic molecules 301”.

Examples of the material for the alignment film 200 include materials commonly used in the field of liquid crystal panels, such as a polymer with a polyimide structure in its main chain, a polymer with a polyamic acid structure in its main chain, and a polymer with a polysiloxane structure in its main chain. The material for the first alignment film 210 and the material for the second alignment film 220 may be different from or same as each other.

The alignment film 200 can be formed by applying an alignment film material. The application method can be any method such as flexographic printing or inkjet coating. The alignment film material for the first alignment film 210 and the alignment film material for the second alignment film 220 may be applied by different methods or by the same method.

The alignment film 200 is preferably a photoalignment film. The photoalignment film can be formed, for example, by applying to a substrate an alignment film material containing a photo-alignment polymer with a photo-functional group. The alignment film 200 is subjected to alignment treatment. For example, the alignment treatment is performed by irradiating the alignment film 200 containing a photo-alignment polymer with polarized ultraviolet rays (also referred to as polarized UV or PUV) to make the surface of the alignment film 200 anisotropic. The photo-alignment polymer in the first alignment film 210 and the photo-alignment polymer in the second alignment film 220 may have different structures or the same structure.

Examples of the photo-alignment polymer include photo-alignment polymers containing at least one photo-functional group selected from the group consisting of cyclobutane, azobenzene, chalcone, cinnamate, coumarin, stilbene, phenol ester, and phenyl benzoate groups. The photo-alignment polymer contained in the photo-alignment film may be one type or two types or more. The photo-functional group contained in the photo-alignment polymer may be located in the main chain of the polymer, in a side chain of the polymer, or in both of the main chain and a side chain of the polymer.

Preferred examples of the photo-alignment polymer include a photolysis polymer, a photo-rearranging polymer (preferably, a photo-Fries rearranging polymer), a photoisomerizable polymer, a photodimerizable polymer, and a photo-crosslinking polymer. Any of these may be used alone or in combination of two or more thereof. In terms of the alignment stability, particularly preferred among these are a photolysis polymer having a reaction wavelength (main sensitive wavelength) around 254 nm and a photo-rearranging polymer having a reaction wavelength (main sensitive wavelength) around 254 nm. Also preferred are a photoisomerizable polymer containing a photo-functional group in a side chain and a photodimerizable polymer containing a photo-functional group in a side chain.

Preferably, the photo-alignment polymer has a main chain structure including at least one selected from a polyamic acid structure, a polyimide structure, a poly(meth)acrylic acid structure, a polysiloxane structure, a polyethylene structure, a polystyrene structure, and a polyvinyl structure.

The alignment film 200 may be a horizontal alignment film that aligns the anisotropic molecules 301 substantially horizontally to the film surface, or may be a vertical alignment film that aligns the anisotropic molecules 301 substantially vertically to the film surface. The horizontal alignment film, with no voltage applied, has a function of aligning the anisotropic molecules 301 in the optically anisotropic layer 300 horizontally to the surface of the horizontal alignment film. Here, the expression “aligning the anisotropic molecules horizontally to the surface of the horizontal alignment film” means that the pre-tilt angle of the anisotropic molecules is from 0° to 5°, preferably from 0° to 2°, more preferably from 0° to 1°, to the surface of the horizontal alignment film. The vertical alignment film, with no voltage applied, has a function of aligning the anisotropic molecules 301 in the optically anisotropic layer 300 vertically to the surface of the vertical alignment film. The expression “aligning the anisotropic molecules vertically to the surface of the vertical alignment film” means that the pre-tilt angle of the anisotropic molecules is from 86° to 90°, preferably from 87° to 89°, more preferably from 87.5° to 89°, to the surface of the vertical alignment film. The pre-tilt angle of the anisotropic molecules means the angle at which the long axes of the liquid crystal molecules tilt relative to the main surface of each substrate with no voltage applied.

The first optically anisotropic layer 310 contains the first anisotropic molecules 311, and the second optically anisotropic layer 320 contains the second anisotropic molecules 321. The first anisotropic molecules 311 and the second anisotropic molecules 321 may be different from or same as each other.

Suitable as the optically anisotropic layer 300 is, for example, a cured product of a polymerizable liquid crystal material (also referred to as “reactive mesogens”). In this case, a polymerizable liquid crystal material in at least one of a polymerized state or an unpolymerized state corresponds to the anisotropic molecules 301. The polymerizable liquid crystal material is preferably a photopolymerizable liquid crystal material that can be cured when irradiated with light.

The optically anisotropic layer 300 can be formed by, for example, applying a polymerizable liquid crystal material (reactive mesogens) and curing the material. The polymerizable liquid crystal material used is a liquid crystal polymer (liquid crystalline polymer) having a photoreactive group. Examples of the polymerizable liquid crystal material include polymers each having a structure with both a substituent (mesogen group) and a photoreactive group in its side chain and having an acrylate, methacrylate, maleimide, N-phenylmaleimide, or siloxane, or another structure in its main chain. The mesogen group may be a biphenyl group, a terphenyl group, a naphthalene group, a phenylbenzoate group, an azobenzene group, or a derivative of any of these groups. The photoreactive group may be a cinnamoyl group, a chalcone group, a cinnamylidene group, a β-(2-phenyl)acryloyl group, a cinnamic acid group, or a derivative of any of these groups. The polymer may be a homopolymer consisting of a single repeat unit or may be a copolymer consisting of two or more repeat units different in side chain structure. The copolymer encompasses all of alternating copolymers, random copolymers, graft copolymers. In the copolymer above, a side chain of at least one repeat unit has a structure including both the mesogen group and the photoreactive group, and a side chain of any other repeat unit may not have the mesogen group or the photoreactive group.

The polymerizable liquid crystal material may contain additives such as a photopolymerization initiator. Non-limiting examples of the photopolymerization initiator include conventionally known ones.

Examples of the solvent used for the polymerizable liquid crystal material include toluene, ethylbenzene, ethylene glycol monomethyl ether, ethylene glycol dimethyl ether, propylene glycol methyl ether, dibutyl ether, acetone, methyl ethyl ketone, ethanol, propanol, cyclohexane, cyclopentanone, methylcyclohexane, tetrahydrofuran, dioxane, cyclohexanone, n-hexane, ethyl acetate, butyl acetate, propylene glycol methyl ether acetate, methoxy butyl acetate, N-methyl pyrrolidone, and dimethylacetamide. Any of these may be used alone or two or more of these may be used in combination.

Next, the method of producing the optical element 10 of the present embodiment is described.

The method of producing the optical element 10 of the present embodiment includes: a first alignment film exposure step of exposing the first alignment film 210 to light for alignment treatment; a first optically anisotropic layer formation step of disposing a first polymerizable liquid crystal material on the exposed first alignment film 210 and curing the first polymerizable liquid crystal material to form a first optically anisotropic layer 310; a second alignment film formation step of disposing a second alignment film 220 on the first optically anisotropic layer 310; a second alignment film exposure step of exposing the second alignment film 220 to light for alignment treatment; and a second optically anisotropic layer formation step of disposing a second polymerizable liquid crystal material on the exposed second alignment film 220 and curing the second polymerizable liquid crystal material to form a second optically anisotropic layer 320. The first alignment film exposure step and the second alignment film exposure step are also simply referred to as “alignment film exposure step”. The first optically anisotropic layer formation step and the second optically anisotropic layer formation step are also simply referred to as “optically anisotropic layer formation step”.

The alignment film exposure step sequentially includes a first exposure step of exposing a first exposure region in the alignment film 200 to first polarized light with a first polarization axis and a second exposure step of exposing a second exposure region in the alignment film 200 overlapping only part of the first exposure region to second polarized light with a second polarization axis that lies at a different angle from the first polarization axis.

This structure enables exposure of the portion of the first exposure region not overlapping the second exposure region to only first polarized light, exposure of the portion of the second exposure region not overlapping the first exposure region to only second polarized light, and exposure of the portion of the first exposure region overlapping the second exposure region to both first polarized light and second polarized light.

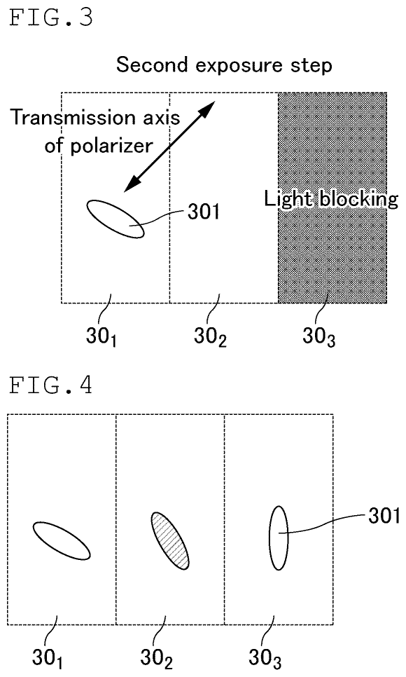

As shown in FIG. 2 to FIG. 4, the molecular alignment in a multi-exposed region is determined by the average of two exposures. Thus, the alignment direction of the alignment film 200 can be varied among the portion of the first exposure region not overlapping the second exposure region, the portion of the second exposure region not overlapping the first exposure region, and the portion of the first exposure region overlapping the second exposure region. In other words, exposure of the alignment film 200 to light twice imparts 3 types of alignment directions to the alignment film 200. As a result, the number of alignment patterns of the anisotropic molecules 301 can be increased with a fewer number of exposures, which enables simpler production of the optical element 10 having high diffraction efficiency. For example, the optical element 10 having high diffraction efficiency can be produced without an increase in the number of masks. FIG. 2 is a schematic view of the first exposure step in the method of producing the optical element of Embodiment 1. FIG. 3 is a schematic view of the second exposure step in the method of producing the optical element of Embodiment 1. FIG. 4 is a schematic view of a state after the first exposure step and the second exposure step in the method of producing the optical element of Embodiment 1.

As shown in FIG. 2 to FIG. 4, the portion of the first exposure region not overlapping the second exposure region corresponds to the first region 301, the portion of the second exposure region not overlapping the first exposure region corresponds to the third region 30₃, and the portion of the first exposure region overlapping the second exposure region, i.e., the multi-exposed region, corresponds to the second region 30₂. In the first region 301 and the third region 30₃, the anisotropic molecules 301 are not twist-aligned in the film thickness direction of the optically anisotropic layer 300, while in the second region 30₂, the anisotropic molecules 301 are twist-aligned in the film thickness direction of the optically anisotropic layer 300.

The method of producing the optical element 10 of the present embodiment may include, before the first alignment film exposure step, a first alignment film formation step of forming the first alignment film 210 by applying an alignment film material containing a photo-alignment polymer with a photo-functional group to the supporting substrate 100. In the first alignment film formation step, a coater such as a slit coater or a spin coater can be suitable for application of the alignment film material. The alignment film material, after being applied to a uniform thickness, for example, may be pre-baked at a temperature of about 70° C. to 100° C. for 1 to 10 minutes.

The second alignment film formation step is similar to the first alignment film formation step. The settings of the first alignment film formation step and the settings of the second alignment film formation step may be different from or same as each other. The first alignment film formation step and the second alignment film formation step are also simply referred to as “alignment film formation step”.

The alignment film exposure step of the present embodiment can be performed by mask exposure. In other words, in the present embodiment, the alignment direction pattern can be obtained by mask exposure. In contrast, in JP 2008-532085 T, the alignment direction pattern corresponds to a polarization hologram. This means that the present embodiment differs from the disclosure of JP 2008-532085 T in the method of forming an optically anisotropic layer.

The alignment film exposure step is a step of exposing the alignment film 200 to light for alignment treatment. The alignment film exposure step is performed, for example, using an exposure device that emits light (ultraviolet rays) with a wavelength of from 313 to 365 nm.

An alignment film exposure step sequentially includes a first exposure step of exposing a first exposure region in the alignment film 200 to first polarized light with a first polarization axis and a second exposure step of exposing a second exposure region in the alignment film 200 overlapping only part of the first exposure region to second polarized light with a second polarization axis that lies at a different angle from the first polarization axis.

Preferably, part of the first exposure region overlaps the second exposure region while the other part of the first exposure region does not overlap the second exposure region, and part of the second exposure region overlaps the first exposure region while the other part of the second exposure region does not overlap the first exposure region. This structure more effectively enables an increase in the number of alignment patterns of the anisotropic molecules 301 with a fewer number of exposures, thus enabling simpler production of the optical element 10 having high diffraction efficiency.

The angle of the second polarization axis is greater than the angle of the first polarization axis preferably by 10° or more and 60° or less, more preferably by 20° or more and 50° or less, still more preferably by 30° or more and 45° or less. This structure can more continuously vary the alignment pattern of the anisotropic molecules 301, thus enabling production of the optical element 10 having higher diffraction efficiency. The angle of an axis herein is measured as positive in the counterclockwise direction.

The alignment film exposure step may include in order the first exposure step and the second exposure step to the M-th exposure step. The first exposure step to the M-th exposure step respectively expose the first exposure region to the M-th exposure region in the alignment film 200 to the first polarized light to the M-th polarized light respectively having the first polarization axis to the M-th polarization axis. The first polarization axis to the M-th polarization axis lie at angles different from one another. Part of the r-th exposure region included in the first exposure region to the M-th exposure region overlaps the (r−1)th exposure region while the other part of the r-th exposure region does not overlap the (r−1)th exposure region. Part of the (r−1)th exposure region included in the first exposure region to the M-th exposure region overlaps the r-th exposure region while the other part of the (r−1)th exposure region does not overlap the r-th exposure region. The r-th exposure region does not overlap the first exposure region to the (r−2)th exposure region. M is an integer of 3 or greater. r is an integer of 3 or greater and M or smaller. This structure can more easily increase the number of alignment patterns of the anisotropic molecules 301, thus enabling simpler production of the optical element 10 having high diffraction efficiency.

M is an integer of 3 or greater, preferably an integer of 4 or greater. M is preferably an integer of 7 or smaller, more preferably an integer of 6 or smaller. M is preferably an integer of 3 or greater and 7 or smaller, more preferably 4 or greater and 6 or smaller.

The angle of the r-th polarization axis is greater than the angle of the (r−1)th polarization axis preferably by 10° or more and 60° or less, more preferably by 200 or more and 50° or less, still more preferably by 30° or more and 45° or less. This structure can more continuously vary the alignment pattern of the anisotropic molecules 301, thus enabling production of the optical element 10 having higher diffraction efficiency.

Specifically, when M is 3, the exposure step further includes a third exposure step after the second exposure step. The third exposure step is a step of exposing the third exposure region in the alignment film 200 to the third polarized light having the third polarization axis. The first polarization axis to the third polarization axis lie at angles different from one another. Part of the third exposure region overlaps the second exposure region while the other part of the third exposure region does not overlap the second exposure region. Part of the second exposure region overlaps the third exposure region while the other part of the second exposure region does not overlap the third exposure region. The third exposure region does not overlap the first exposure region.

The angle of the third polarization axis is greater than the angle of the second polarization axis preferably by 10° or more and 600 or less, more preferably by 200 or more and 50° or less, still more preferably by 30° or more and 45° or less. This structure can more continuously vary the alignment pattern of the anisotropic molecules 301, thus enabling production of the optical element 10 having higher diffraction efficiency.

When M is 4, the exposure step may further include the third exposure step and the fourth exposure step after the second exposure step. The third exposure step and the fourth exposure step are steps that respectively expose the third exposure region and the fourth exposure region of the alignment film 200 to the third polarized light and the fourth polarized light respectively having the third polarization axis and the fourth polarization axis. The first polarization axis to the fourth polarization axis lie at angles different from one another. Part of the third exposure region overlaps the second exposure region while the other part of the third exposure region does not overlap the second exposure region. Part of the second exposure region overlaps the third exposure region while the other part of the second exposure region does not overlap the third exposure region. The third exposure region does not overlap the first exposure region. Part of the fourth exposure region overlaps the third exposure region while the other part of the fourth exposure region does not overlap the third exposure region. Part of the third exposure region overlaps the fourth exposure region while the other part of the third exposure region does not overlap the fourth exposure region. The fourth exposure region does not overlap the first exposure region and the second exposure region.

The angle of the fourth polarization axis is greater than the angle of the third polarization axis preferably by 100 or more and 60° or less, more preferably by 20° or more and 50° or less, still more preferably by 30° or more and 45° or less. This structure can more continuously vary the alignment pattern of the anisotropic molecules 301, thus enabling production of the optical element 10 having higher diffraction efficiency.

The settings of the first alignment film exposure step and the settings of the second alignment film exposure step may be different from or same as each other.

The optically anisotropic layer formation step is a step of disposing a polymerizable liquid crystal material on the exposed alignment film 200 and curing the polymerizable liquid crystal material. In the optically anisotropic layer formation step, the polymerizable liquid crystal material is disposed on the alignment film 200 by coating, for example. A coater such as a slit coater or a spin coater is suitable for the coating. The polymerizable liquid crystal material is cured using, for example, an exposure device that emits light (ultraviolet rays) having a wavelength of from 313 to 365 nm.

The settings of the first optically anisotropic layer formation step and the settings of the second optically anisotropic layer formation step may be different from or same as each other.

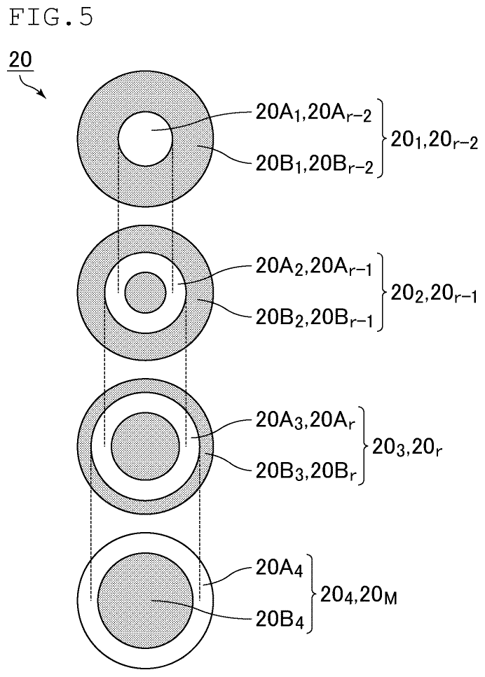

FIG. 5 is a schematic plan view of an example of a mask set for use in production of the optical element of Embodiment 1. The optical element 10 of the present embodiment can be produced using a mask set 20 shown in FIG. 5. The mask set 20 includes a first mask 20₁ having a first light-transmitting portion (opening portion) 20A₁ and a first light-blocking portion 20B₁ and a second mask 20₂ having a second light-transmitting portion 20A₂ and a second light-blocking portion 20B₂. In a state where the first mask 20₁ and the second mask 20₂ are overlaid with each other with the center of the first mask 20₁ and the center of the second mask 20₂ coinciding with each other, the first light-transmitting portion 20A₁ overlaps part of the second light-transmitting portion 20A₂ and part of the second light-blocking portion 20B₂, and the second light-transmitting portion 20A₂ overlaps part of the first light-transmitting portion 20A₁ and part of the first light-blocking portion 20B₁. This structure enables production of the optical element 10 using, in the production step, the first mask 20₁ for the first exposure step and the second mask 20₂ for the second exposure step.

As described above, the mask set 20 used to produce the optical element 10 of the present embodiment includes annular masks in each of which a light-transmitting portion alternates with a light-blocking portion. The annular masks are designed such that on the alignment film 200, a region irradiated with multiple types of polarized UV with different polarization axes alternates with a region irradiated with one type of polarized UV without being irradiated with other types of polarized UV with different polarization axes.

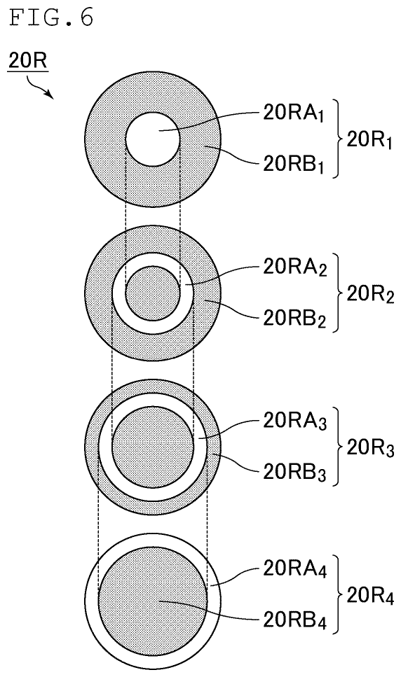

When the exposure is performed through multiple masks, usually, for example, a mask set 20R shown in FIG. 6 is used. FIG. 6 is a schematic plan view of an example of a common mask set. As shown in FIG. 6, the common mask set 20R includes a first mask 20R₁ having a light-transmitting portion 20RA₁ and a light-blocking portion 20RB₁, a second mask 20R₂ having a light-transmitting portion 20RA₂ and a light-blocking portion 20RB₂, a third mask 20R₃ having a light-transmitting portion 20RA₃ and a light-blocking portion 20RB₃, and a fourth mask 20R₄ having a light-transmitting portion 20RA₄ and a light-blocking portion 20RB₄. In a state where the first mask 20R₁ to the fourth mask 20R₄ are overlaid with one another with the center of the first mask 20R₁ to the center of the fourth mask 20R₄ coinciding with one another, the light-transmitting portions of the masks do not overlap one another.

As described above, the optical element 10 of the present embodiment can be produced by optical patterning of exposing the alignment film 200 containing a photo-alignment polymer to light in multiple predetermined patterns such that the alignment film 200 is patterned in the desired pattern through the multiple exposures. The first light-transmitting portion 20A₁, the first light-blocking portion 20B₁, the second light-transmitting portion 20A₂, and the second light-blocking portion 20B₂ each have a concentrical pattern with a predetermined width. The first mask 20₁ and the second mask 20₂ have patterns different from each other.

As shown in FIG. 5, the mask set 20 may include the first mask 20₁ and the second mask 20₂ to an M-th mask 20_{M}. An r-th mask 20ᵣ included in the first mask 20₁ to the M-th mask 20_{M} includes an r-th light-transmitting portion 20Aᵣ and an r-th light-blocking portion 20Bᵣ. An (r−1)th mask 20ᵣ₋₁ included in the first mask 20₁ to the M-th mask 20_{M} includes an (r−1)th light-transmitting portion 20Aᵣ₋₁ and an (r−1)th light-blocking portion 20Bᵣ₋₁. An (r−2)th mask 20ᵣ₋₂ included in the first mask 20₁ to the M-th mask 20_{M} includes an (r−2)th light-transmitting portion 20Aᵣ₋₂ and an (r−2)th light-blocking portion 20Bᵣ₋₂. In a state where the central portion of the r-th mask 20ᵣ and the central portion of the (r−1)th mask 20ᵣ₋₁ coincide with each other, the (r−1)th light-transmitting portion 20Aᵣ₋₁ overlaps part of the r-th light-transmitting portion 20Aᵣ and part of the r-th light-blocking portion 20Bᵣ, and the r-th light-transmitting portion 20Aᵣ overlaps part of the (r−1)th light-transmitting portion 20Aᵣ₋₁ and part of the (r−1)th light-blocking portion 20Bᵣ₋₁ while not overlapping the (r−2)th light-transmitting portion 20Aᵣ₋₂. M is an integer of 3 or greater. r is an integer of 3 or greater and M or smaller. This structure can more easily increase the number of alignment patterns of the anisotropic molecules 301, thus enabling simpler production of the optical element 10 having high diffraction efficiency.

Specifically, when M is 3, the mask set 20 further includes the third mask 20₃ in addition to the first mask 20₁ and the second mask 20₂. The third mask 20₃ includes a third light-transmitting portion 20A₃ and a third light-blocking portion 20B₃. In a state where the central portion of the third mask 20₃ and the central portion of the second mask 20₂ coincide with each other, the second light-transmitting portion 20A₂ overlaps part of the third light-transmitting portion 20A₃ and part of the third light-blocking portion 20B₃ and the third light-transmitting portion 20A₃ overlaps part of the second light-transmitting portion 20A₂ and part of the second light-blocking portion 20B₂ while not overlapping the first light-transmitting portion 20A₁. This structure enables production of the optical element 10 using, in the production step, the third mask 20₃ for the third exposure step.

Specifically, when M is 4, the mask set 20 further includes the third mask 20₃ and a fourth mask 20₄ in addition to the first mask 20₁ and the second mask 20₂. The fourth mask 20₄ includes a fourth light-transmitting portion 20A₄ and a fourth light-blocking portion 20B₄. In a state where the central portion of the fourth mask 20₄ and the central portion of the third mask 20₃ coincide with each other, the third light-transmitting portion 20A₃ overlaps part of the fourth light-transmitting portion 20A₄ and part of the fourth light-blocking portion 20B₄ and the fourth light-transmitting portion 20A₄ overlaps part of the third light-transmitting portion 20A₃ and part of the third light-blocking portion 20B₃ while not overlapping the first light-transmitting portion 20A₁ and the second light-transmitting portion 20A₂. This structure enables production of the optical element 10 using, in the production step, the third mask 20₃ for the third exposure step and the fourth mask 20₄ for the fourth exposure step.

Each mask of the mask set 20 includes a concentrical light-transmitting portion and a concentrical light-blocking portion. The light-transmitting portion transmits light and has a transmittance of, for example, 80% or higher and 100% or lower. The light-blocking portion does not transmit light and has a transmittance of, for example, 0% or higher and 10% or lower.

### Embodiment 2

In the present embodiment, features unique to the present embodiment are mainly described, and description of matters already described in Embodiment 1 is omitted. The optical element of the present embodiment includes a third alignment film and a third optically anisotropic layer in addition to the structure in Embodiment 1.

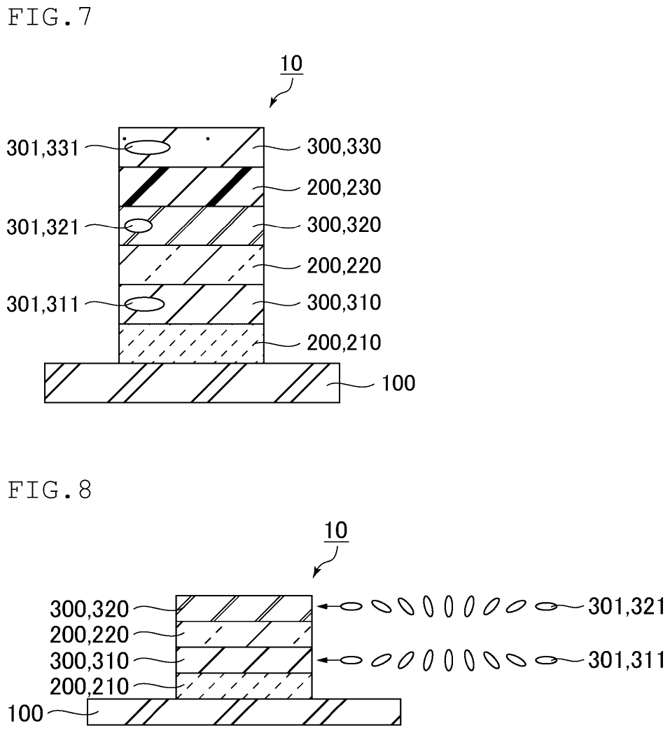

FIG. 7 is a schematic cross-sectional view of an optical element of Embodiment 2. As shown in FIG. 7, the optical element 10 of the present embodiment includes, in addition to the structure in Embodiment 1, the third alignment film 230 disposed on the surface of the second optically anisotropic layer 320 opposite to the second alignment film 220; and the third optically anisotropic layer 330 disposed on the surface of the third alignment film 230 opposite to the second optically anisotropic layer 320 and containing the third anisotropic molecules 331. This structure further increases the design flexibility owing to the larger number of optically anisotropic layers than in Embodiment 1 and enables more favorable optical characteristics.

The third alignment film 230 is similar to the alignment film 200. The first alignment film 210, the second alignment film 220, and the third alignment film 230 may be different from each other or at least two of them may be the same as each other.

The third optically anisotropic layer 330 is similar to the optically anisotropic layer 300. The first optically anisotropic layer 310, the second optically anisotropic layer 320, and the third optically anisotropic layer 330 may be different from each other or at least two of them may be the same as each other.

The third anisotropic molecules 331 are similar to the anisotropic molecules 301. The first anisotropic molecules 311, the second anisotropic molecules 321, and the third anisotropic molecules 331 may be different from one another or at least two of these types of molecules may be the same as each other.

With the azimuthal angle of the slow axis of the first optically anisotropic layer 310 being set at 0°, preferably, the azimuthal angle of the slow axis of the second optically anisotropic layer 320 is greater than 350 and smaller than 50°, the azimuthal angle of the slow axis of the third optically anisotropic layer 330 is greater than −25° and smaller than 25°. This structure enables high diffraction efficiency over a broad visible wavelength range from 450 nm to 650 nm.

An azimuth means the direction in question in a view projected onto the optical element and is expressed as an angle (azimuthal angle) formed with the reference azimuth. Here, the reference azimuth (0°) is set at the azimuth of the slow axis of the first optically anisotropic layer. An azimuthal angle is measured as positive in the counterclockwise direction from the reference azimuth and as negative in the clockwise direction from the reference azimuth. Both the counterclockwise and clockwise directions are rotation directions when the optical element is viewed from the observation surface side (front). The angle is a value measured in a plan view of the optical element.

In the state where the azimuthal angle of the slow axis of the second optically anisotropic layer 320 is greater than 350 and smaller than 50° and the azimuthal angle of the slow axis of the third optically anisotropic layer 330 is greater than −25° and smaller than 25°, preferably, the phase difference of the first optically anisotropic layer 310 provided to light with a wavelength of 550 nm is 120 nm or more and 150 nm or less, the phase difference of the second optically anisotropic layer 320 provided to light with a wavelength of 550 nm is 150 nm or more and 350 nm or less, and the phase difference of the third optically anisotropic layer 330 provided to light with a wavelength of 550 nm is 120 nm or more and 150 nm or less. This structure enables higher diffraction efficiency over a broad visible wavelength range from 450 nm to 650 nm.

A phase difference (Re) refers to an in-plane phase difference of a layer (film) at 23° C. and, unless otherwise specified, a wavelength of 550 nm. Re can be determined from the equation Re=(nx−ny)×d, where d (nm) is the thickness of the layer (film). Herein, a “phase difference” refers to an in-plane phase difference, unless otherwise specified.

“nx” is the refractive index in a direction in which the in-plane refractive index is maximum (i.e., slow axis direction). “ny” is the refractive index in a direction orthogonal to the slow axis in the plane. “nz” is the refractive index in the thickness direction. A refractive index refers to, unless otherwise specified, a value at 23° C. for light with a wavelength of 550 nm.

With the azimuthal angle of the slow axis of the first optically anisotropic layer 310 being set at 0°, preferably, the azimuthal angle of the slow axis of the second optically anisotropic layer 320 is greater than 35° and smaller than 50°, and the azimuthal angle of the slow axis of the third optically anisotropic layer 330 is greater than −5° and smaller than 5°. This structure enables even higher diffraction efficiency over a broad visible wavelength range from 450 nm to 650 nm.

In the state where the azimuthal angle of the slow axis of the second optically anisotropic layer 320 is greater than 35° and smaller than 50° and the azimuthal angle of the slow axis of the third optically anisotropic layer 330 is greater than −5° and smaller than 5°, preferably, the phase difference of the first optically anisotropic layer 310 provided to light with a wavelength of 550 nm is 120 nm or more and 150 nm or less, the phase difference of the second optically anisotropic layer 320 provided to light with a wavelength of 550 nm is 210 nm or more and 290 nm or less, and the phase difference of the third optically anisotropic layer 330 provided to light with a wavelength of 550 nm is 120 nm or more and 150 nm or less. This structure enables even higher diffraction efficiency over a broad visible wavelength range from 450 nm to 650 nm.

For example, the azimuthal angle of the slow axis of the first optically anisotropic layer 310 is 0° and the phase difference of the first optically anisotropic layer 310 is λ/4; the azimuthal angle of the slow axis of the second optically anisotropic layer 320 is 45° and the phase difference of the second optically anisotropic layer 320 is λ/2; and the azimuthal angle of the slow axis of the third optically anisotropic layer 330 is 0° and the phase difference of the third optically anisotropic layer 330 is λ/4.

The optical element 10 of the present embodiment is a PB lens that can exhibit high diffraction efficiency over a broad visible wavelength range from 450 nm to 650 nm. For example, in the optical element 10 of the present embodiment, the broadband effect can be accomplished using three waveplates of λ/4, λ/2, and λ/4 plates. The optical element 10 is a broadband half-wave plate that converts circularly polarized light to circularly polarized light. The half-wave plate in the PB lens may not necessarily be a single-layer RM layer (A-plate) as long as it is a half-wave plate that converts right-handed circularly polarized light to left-handed circularly polarized light or left-handed circularly polarized light to right-handed circularly polarized light. In the present embodiment, three RM layers exhibiting positive wavelength dispersion are laminated with alignment films interposed in between to achieve the broadband half-wave plate described above.

In contrast, in JP 2008-532085 T, two λ/2 plates are used to accomplish the broadband effect. The polarization grating in JP 2008-532085 T is a broadband half-wave plate that converts linearly polarized light to linearly polarized light.

A λ/4 plate introduces a phase difference of 100 nm or more and 176 nm or less to light having a wavelength of 550 nm, and is preferably a phase difference plate that introduces a phase difference of a quarter of a wavelength (strictly, 137.5 nm) to light having a wavelength of 550 nm. A λ/2 plate introduces a phase difference of 238 nm or more and 313 nm or less to light having a wavelength of 550 nm, and is preferably a phase difference plate that introduces a phase difference of a half of a wavelength (strictly, 275 nm) to light having a wavelength of 550 nm. Light having a wavelength of 550 nm is light having a wavelength to which the human eye has highest sensitivity.

The method of producing the optical element 10 of the present embodiment includes: a first alignment film exposure step of exposing the first alignment film 210 to light for alignment treatment; a first optically anisotropic layer formation step of disposing a first polymerizable liquid crystal material on the exposed first alignment film 210 and curing the first polymerizable liquid crystal material to form the first optically anisotropic layer 310; a second alignment film formation step of disposing the second alignment film 220 on the first optically anisotropic layer 310; a second alignment film exposure step of exposing the second alignment film 220 to light for alignment treatment; a second optically anisotropic layer formation step of disposing a second polymerizable liquid crystal material on the exposed second alignment film 220 and curing the second polymerizable liquid crystal material to form the second optically anisotropic layer 320; a third alignment film formation step of disposing the third alignment film 230 on the second optically anisotropic layer 320; a third alignment film exposure step of exposing the third alignment film 230 to light for alignment treatment; and a third optically anisotropic layer formation step of disposing a third polymerizable liquid crystal material on the exposed third alignment film 230 and curing the third polymerizable liquid crystal material to form the third optically anisotropic layer 330.

The third alignment film formation step is similar to the alignment film formation step described above. At least two of the settings of the first alignment film formation step, the settings of the second alignment film formation step, or the settings of the third alignment film formation step may be different from one another or all of these settings may be the same as one another.

The third alignment film exposure step is similar to the alignment film exposure step described above. At least two of the settings of the first alignment film exposure step, the settings of the second alignment film exposure step, or the settings of the third alignment film exposure step may be different from one another or all of these settings may be the same as one another.

The third optically anisotropic layer formation step is similar to the optically anisotropic layer formation step described above. At least two of the settings of the first optically anisotropic layer formation step, the settings of the second optically anisotropic layer formation step, or the settings of the third optically anisotropic layer formation step may be different from one another or all of these settings may be the same as one another.

### Embodiment 3

In the present embodiment, features unique to the present embodiment are mainly described, and description of matters already described in Embodiment 1 is omitted. In the optical element 10 of the present embodiment, the rotation direction of the first anisotropic molecules 311 in the optical element 10 of Embodiment 1 is made opposite to the rotation direction of the second anisotropic molecules 321.

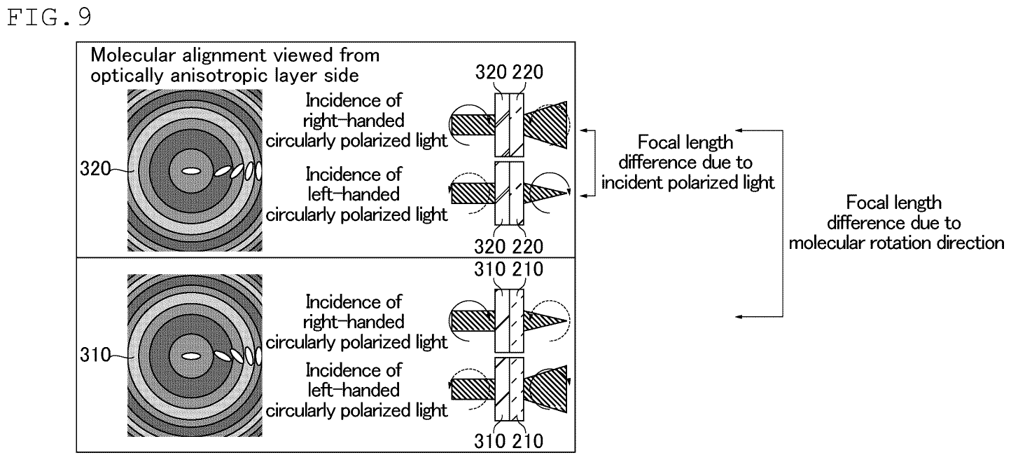

FIG. 8 is a schematic cross-sectional view of an optical element of Embodiment 3. FIG. 9 shows the molecular alignments of anisotropic molecules superimposed on micrographs of a first optically anisotropic layer and a second optically anisotropic layer in the optical element of Embodiment 3. As shown in FIG. 8 and FIG. 9, in a plan view, the alignment directions of the first anisotropic molecules 311 and the alignment directions of the second anisotropic molecules 321 in the present embodiment are set to rotate in the plane from the central portion toward the end portion of the optical element 10. The rotation direction of the first anisotropic molecules 311 is opposite to the rotation direction of the second anisotropic molecules 321.

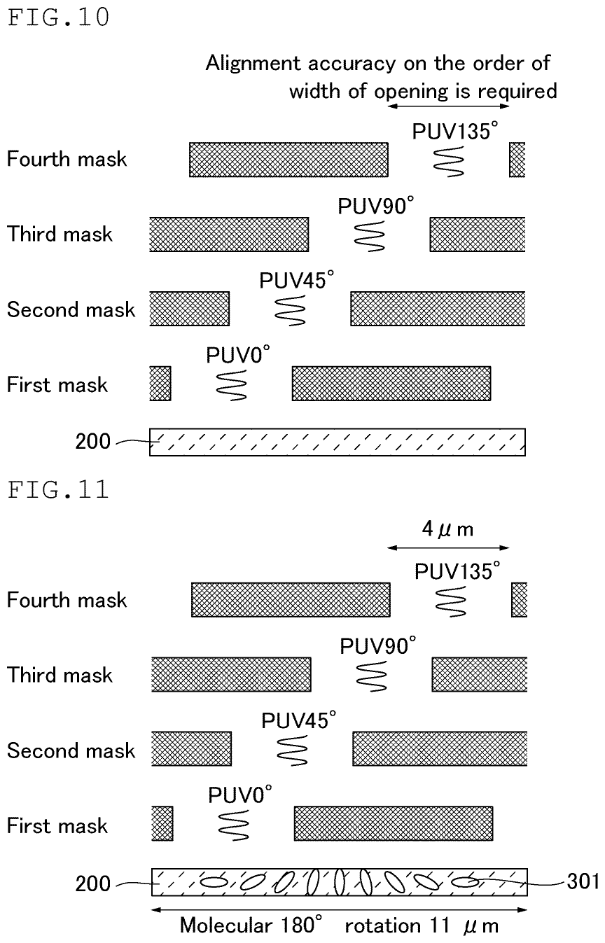

As shown in FIG. 10, in production of a PB lens through multiple mask exposures, the alignment accuracy is important. For example, as shown in FIG. 11, production of a lens with a focal length of 50 cm and a diameter of 5 cm requires alignment accuracy on the order of several micrometers. FIG. 10 is a schematic view illustrating the case of producing a PB lens through multiple mask exposures. FIG. 11 is a schematic view showing a specific example of the case of producing a PB lens through multiple mask exposures.

As described above, the shorter the focal length of the PB lens, or the greater the lens diameter, the higher the alignment accuracy required, making the production more difficult.

In contrast, in the present embodiment, in a plan view, the alignment directions of the first anisotropic molecules 311 and the alignment directions of the second anisotropic molecules 321 each rotate in the plane from the central portion toward the end portion of the optical element 10, and the rotation direction of the first anisotropic molecules 311 is opposite to the rotation direction of the second anisotropic molecules 321. This structure enables lamination of multiple PB lenses. A laminate of multiple PB lenses has a refractive power equal to the sum of refractive powers of the multiple PB lenses, which makes it possible to produce a short focus lens using lenses with a long molecular rotation period. As a result, a short focus lens can be more easily produced. As described above, in the present embodiment, the alignment accuracy required can be lowered to facilitate production of a PB lens.

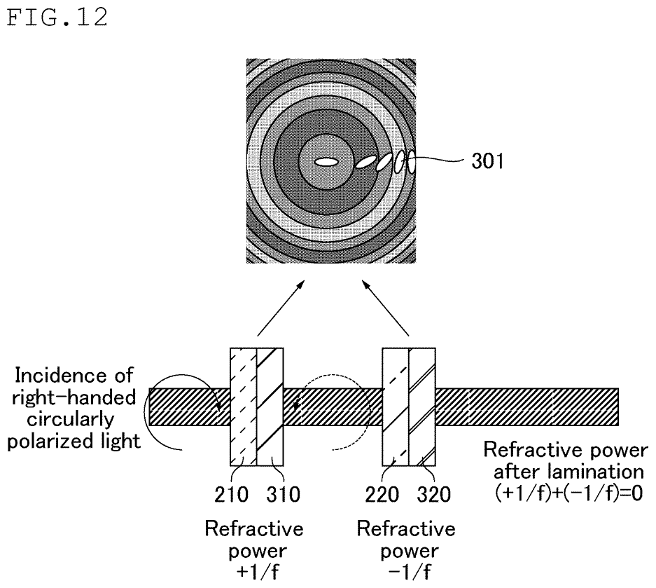

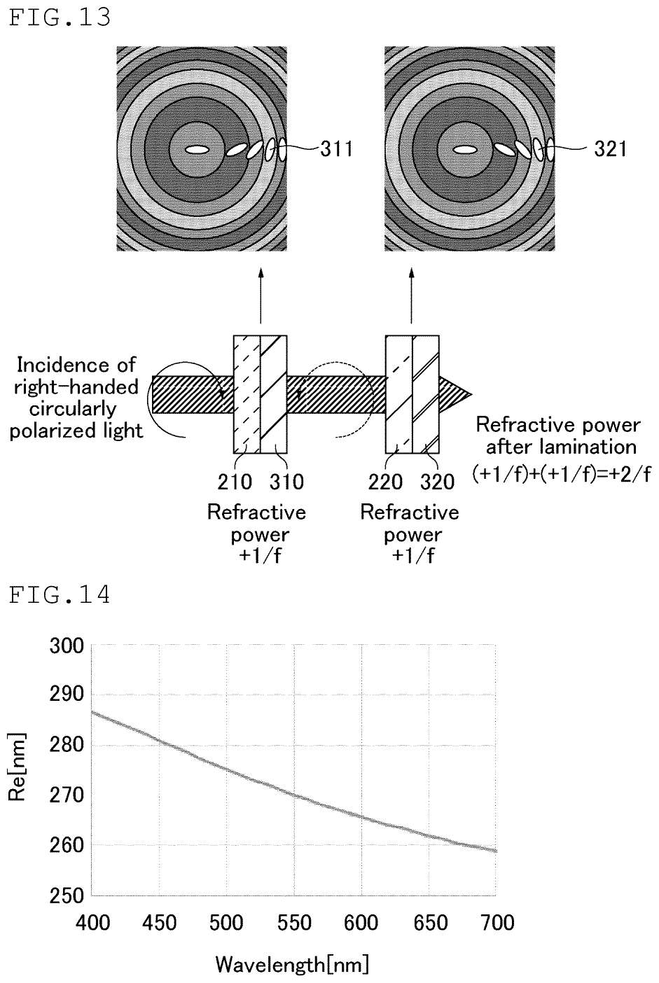

Also, as shown in FIG. 9, the sign of the focal length of the PB lens depends not only on the rotation direction of the incident circularly polarized light but also on the rotation direction of the molecules. Thus, in order to increase the refractive power by laminating two PB lenses, as shown in FIG. 12 and FIG. 13, the rotation directions of molecules in the first layer and that in the second layer need to be opposite. FIG. 12 is a view illustrating the case where molecular rotation directions of two PB lenses are the same. FIG. 13 is a view illustrating the case where molecular rotation directions of two PB lenses are opposite.

In other words, as shown in FIG. 12, when the molecular rotation directions of two PB lenses are the same, the refractive power of the first optically anisotropic layer 310 is +1/f and the refractive power of the second optically anisotropic layer 320 is −1/f, so that the refractive power of the laminate of these layers is (+1/f)+(−1/f)=0. In contrast, as shown in FIG. 13, when the molecular rotation directions of two PB lenses are opposite, the refractive power of the first optically anisotropic layer 310 is +1/f and the refractive power of the second optically anisotropic layer 320 is also +1/f, so that the refractive power of the laminate of these layers is (+1/f)+(+1/f)=+2/f.

In the optical element 10 of the present embodiment, the first alignment film 210 is used to align the first anisotropic molecules 311 and the second alignment film 220 is used to align the second anisotropic molecules 321 to make the in-plane patterns of the alignment directions of the first anisotropic molecules 311 and the second anisotropic molecules 321 opposite to each other, thus increasing the refractive power.

In contrast, the polarization grating disclosed in JP 2008-532085 T has a structure including a laminate of PB lenses, but the in-plane patterns of the molecular alignments of the two PB lenses are the same, which differs from the structure of the present embodiment.

For example, the phase difference of the first optically anisotropic layer 310 is λ/2, and the phase difference of the second optically anisotropic layer 320 is λ/2.

Preferably, the optical element 10 of the present embodiment satisfies the following Formula A. This structure enables an optical element with a short focal length even in a case where the period over which molecules rotate 180° is long.

$$Molecular alignment [ ° ] < 90 / ( Wavelength [ m ] ) / ( Focal length [ m ] ) * {( Distance from center of lens [ m ] )}^{2} \qquad ( Formula A )$$

In the Formula A, the molecular alignment represents the azimuthal angle of the molecular alignment of each of the first anisotropic molecules or each of the second anisotropic molecules; the wavelength represents the wavelength of incident light; the focal length represents the focal length of the optical element; and the distance from the center of the lens represents the distance from the center of the lens to the first anisotropic molecule or the second anisotropic molecule.

### EXAMPLES

The present invention is described in more detail below with reference to examples and comparative examples.

### Comparative Example 1

In Comparative Example 1, RMs exhibiting positive wavelength dispersion were used to produce a half-wave plate, on which the phase difference measurement was then performed. The positive wavelength dispersion here means the wavelength dependence of the phase difference, where the phase difference measured at longer wavelengths is smaller than the phase difference measured at shorter wavelengths.

The procedure of producing the half-wave plate of Comparative Example 1 is described below. First, a photoalignment film containing photoisomerizable polymer was formed on a glass substrate, followed by irradiation with polarized UV with 100 mJ/cm² (365 nm). After being irradiated with polarized UV, the workpiece was baked in a 160° C. oven for 20 minutes, and RMs were applied to the baked workpiece. The RMs were applied with a spin coater spinning at 1000 rpm to such a thickness that a retardation (phase difference) provided to light with a wavelength of 550 nm would be about 270 nm.

The RM layer (optically anisotropic layer) exhibited positive wavelength dispersion and ratios of Re (450 nm)/Re (550 nm)≈1.04 and Re (650 nm)/Re (550 nm)≈0.97. The applied RMs were cured with unpolarized UV with 200 mJ (365 nm), whereby the half-wave plate of Comparative Example 1 was obtained. The phase difference is also referred to as retardation or Re.

### <Phase Difference Measurement>

AxoScan was used to measure the phase difference of the half-wave plate in Comparative Example 1. The measurement wavelength was set to 400 nm to 700 nm. The results are shown in FIG. 14. FIG. 14 is a graph showing a phase difference of a half-wave plate in Comparative Example 1.

### <Calculation of Diffraction Efficiency>

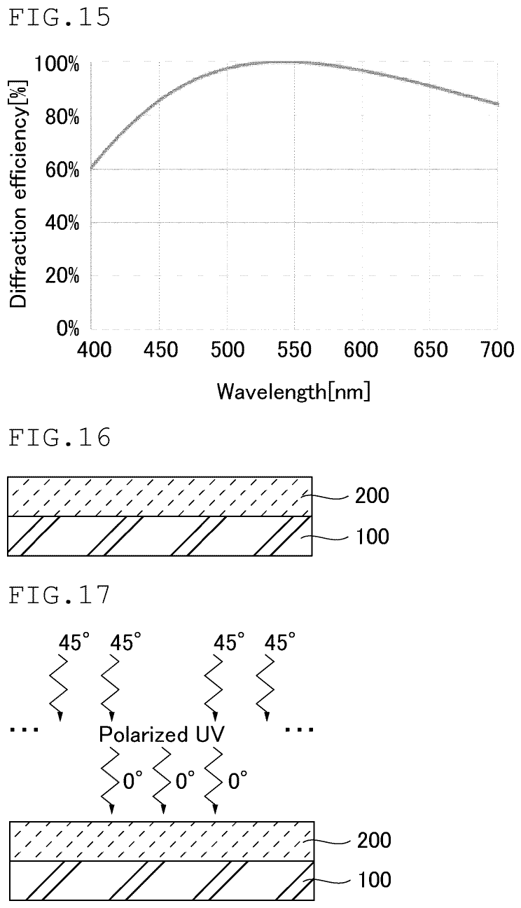

The diffraction efficiency of a PB lens produced using the half-wave plate (phase difference plate) in Comparative Example 1 was calculated. The results are shown in FIG. 15. FIG. 15 is a graph showing the calculated diffraction efficiency values of the half-wave plate in Comparative Example 1. When the retardation of the phase difference plate is denoted as and, the diffraction efficiency value is proportional to “sin(Δnd/λ×π)²”.

### Reference Example 1

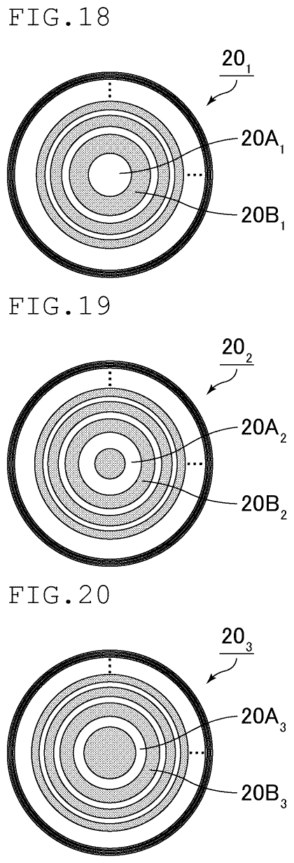

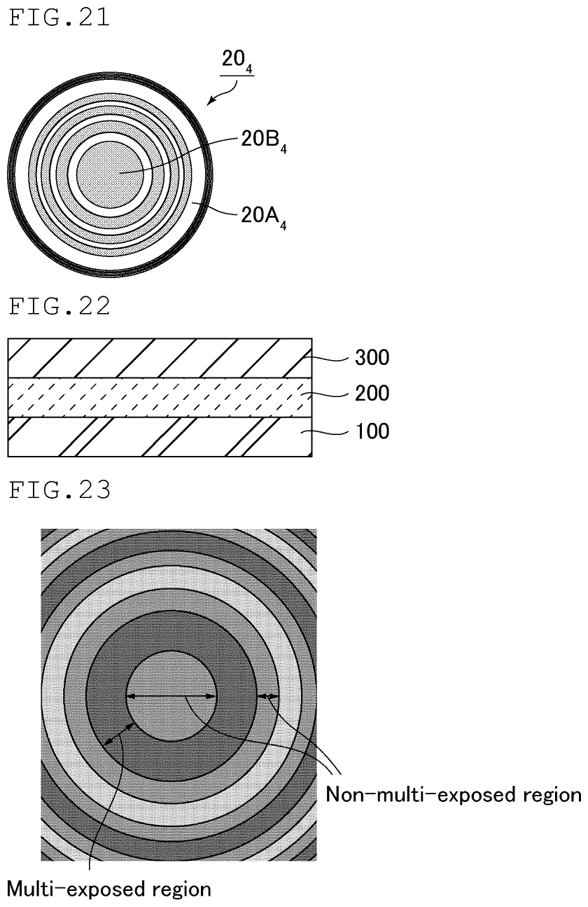

FIG. 16 is a schematic cross-sectional view illustrating an alignment film formation step included in a step of producing a PB lens of Reference Example 1. FIG. 17 is a schematic cross-sectional view illustrating an alignment film exposure step included in the step of producing the PB lens of Reference Example 1. FIG. 18 is a schematic view showing a mask used to apply polarized UV with a polarization axis at 0° in the alignment film exposure step included in the step of producing the PB lens of Reference Example 1. FIG. 19 is a schematic view showing a mask used to apply polarized UV with a polarization axis at 45° in the alignment film exposure step included in the step of producing the PB lens of Reference Example 1. FIG. 20 is a schematic view showing a mask used to apply polarized UV with a polarization axis at 90° in the alignment film exposure step included in the step of producing the PB lens of Reference Example 1. FIG. 21 is a schematic view showing a mask used to apply polarized UV with a polarization axis at 1350 in the alignment film exposure step included in the step of producing the PB lens of Reference Example 1. FIG. 22 is a schematic cross-sectional view illustrating an optically anisotropic layer formation step included in the step of producing the PB lens of Reference Example 1. FIG. 23 is a micrograph of the PB lens of Reference Example 1.

In Reference Example 1, the RMs exhibiting positive wavelength dispersion used in Comparative Example 1 were used to produce a PB lens. The procedure of producing the PB lens of Reference Example 1 is shown below. First, as shown in FIG. 16, a photoalignment film (alignment film 200) containing a photoisomerizable polymer was formed on a glass substrate (supporting substrate 100) (alignment film formation step).

Thereafter, as shown in FIG. 17, the alignment film 200 was irradiated with polarized UV with 100 mJ/cm² (365 nm) (alignment film exposure step). The alignment film exposure step included a first exposure step, a second exposure step, a third exposure step, and a fourth exposure step. In the first exposure step, the annular mask (first mask 20₁) shown in FIG. 18 in which the first light-transmitting portion (opening) 20A₁ alternated with the first light-blocking potion 20B₁ was used, and the first polarization axis was set at 0°. In the second exposure step, the annular mask (second mask 20₂) shown in FIG. 19 in which the second light-transmitting portion (opening) 20A₂ alternated with the second light-blocking potion 20B₂ was used, and the second polarization axis was set at 45°. In the third exposure step, the annular mask (third mask 20₃) shown in FIG. 20 in which the third light-transmitting portion (opening) 20A₃ alternated with the third light-blocking potion 20B₃ was used, and the third polarization axis was set at 90°. In the fourth exposure step, the annular mask (fourth mask 20₄) shown in FIG. 21 in which the fourth light-transmitting portion (opening) 20A₄ alternated with the fourth light-blocking potion 20B₄ was used, and the fourth polarization axis was set at 135°.

After being irradiated with the polarized UV lights, the workpiece was baked in a 160° C. oven for 20 minutes, and RMs were applied to the baked workpiece as shown in FIG. 22. The RMs were applied with a spin coater spinning at 1000 rpm to such a thickness that the phase difference provided to light with a wavelength of 550 nm would be about 270 nm. In other words, the RMs were applied such that the optically anisotropic layer 300 would provide a phase difference of λ/2.

The RM layer exhibited positive wavelength dispersion and ratios of Re (450 nm)/Re (550 nm)≈1.04 and Re (650 nm)/Re (550 nm)≈0.97. The applied RMs were cured with unpolarized UV with 200 mJ (365 nm) (optically anisotropic layer formation step), whereby the PB lens of Reference Example 1 was obtained.

The PB lens of Reference Example 1 was observed with a polarizing microscope. The results are shown in FIG. 23. FIG. 23 confirms that the RMs were normally aligned in the PB lens of Reference Example 1.

### <Measurement of Focal Length>

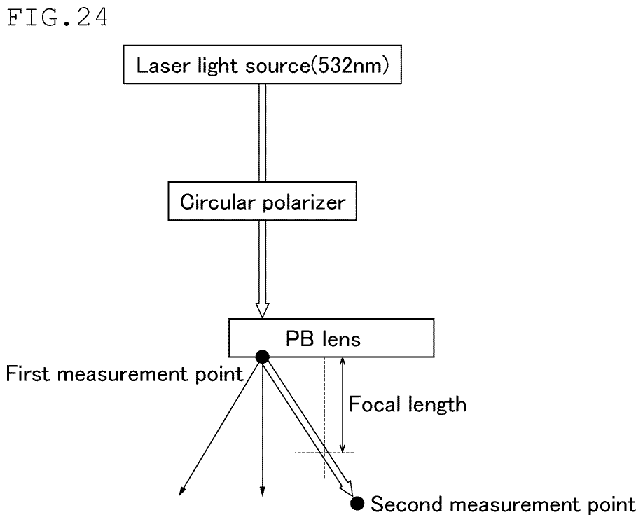

FIG. 24 is a schematic view showing a focal length measurement method. As shown in FIG. 24, the outer periphery of the PB lens of Reference Example 1 was irradiated with 532 nm laser light to measure the focal length with a ruler. The laser light first passes through the circular polarizer to be circularly polarized light and emitted. Principal light of the light having passed through the outer periphery of the PB lens travels toward the focal point.

### <Measurement Results>

The measured focal length of the PB lens of Reference Example 1 was 50 cm. The focal length of the PB lens is related to the period of the molecular alignment pattern. The following Formula 1 holds between the focal length and the molecular alignment.

$$Molecular alignment [ ° ] = 90 / ( Wavelength [ m ] ) / ( Focal length [ m ] ) * {( Distance from center of lens [ m ] )}^{2} \qquad ( Formula 1 )$$

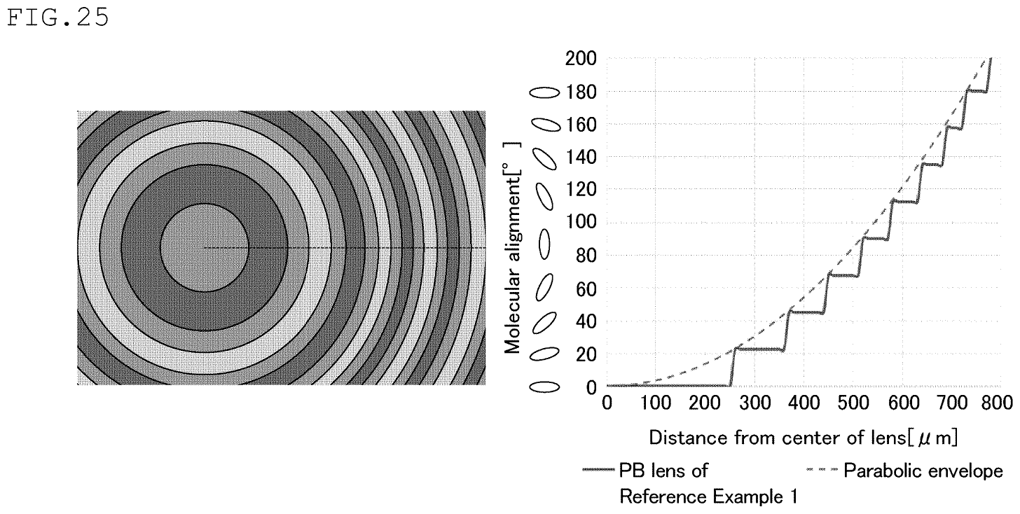

FIG. 25 shows a micrograph of the PB lens of Reference Example 1 and a graph showing the relationship between the molecular alignment and the distance from the center of the lens. The graph in FIG. 25 relates to the portion indicated by the dashed line in the micrograph.

The relationship between the molecular alignment of the PB lens of Reference Example 1 and the distance from the center of the lens was as shown in FIG. 25. The formula of the envelope represented by the (parabolic) graph in FIG. 25 is expressed by the following Formula 2.

$$Molecular alignment [ ° ] = 3.38 * {10}^{8} * {( Distance from center of lens [ m ] )}^{2} \qquad ( Formula 2 )$$

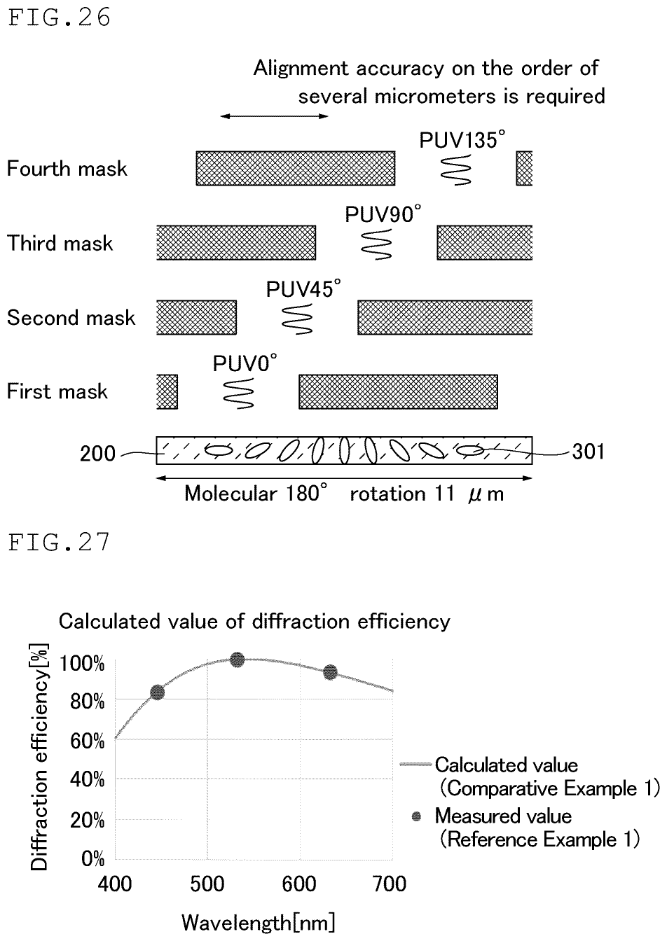

Comparison between the factors of proportionality in the above Formula 1 and the above Formula 2 demonstrated that when the wavelength was 532 nm, the focal length was 50 cm. In order to shorten the focal length, the factor of proportionality needs to be further increased. This means that the period taken for anisotropic molecules to rotate 1800 becomes shorter. A shorter period may cause production problems. When a PB lens is produced through multiple mask exposures, the order of mask alignment accuracy needs to be shorter than the molecular rotation period. For example, when a lens with a focal length of 50 cm and a diameter of 5 cm is produced, as shown in FIG. 26, the shortest molecular rotation period among the regions is 11 μm. Thus, the mask alignment accuracy needs to be on the order of several micrometers, with which a mask may not be producible depending on the performance of the alignment device. FIG. 26 is a schematic view showing a specific example of the case of producing a PB lens through multiple mask exposures.

### <Method of Evaluating Diffraction Efficiency>

The diffraction efficiency of the PB lens of Reference Example 1 was measured. The diffraction efficiency was measured using the structure shown in FIG. 24 with three laser light sources respectively having wavelengths of 445 nm, 532 nm, and 632 nm. In the measurement of the diffraction efficiency, light emitted from each laser light source first passes through the circular polarizer to be circularly polarized light and emitted toward the PB lens. Principal light of the light having passed through the outer periphery of the PB lens travels toward the focal point. Meanwhile, unnecessary light such as the zeroth-order light is diffracted in a different direction from the principal light. The diffraction efficiency is defined by the following Formula 3.

$$Diffraction efficiency = ( Principal light intensity ) \div ( Total transmission light intensity ) \times 100 \qquad ( Formula 3 )$$

Thus, the light intensity was measured at the first measurement point and the second measurement point shown in FIG. 24. The light intensity measured at the first measurement point was taken as the total transmission light intensity. The light intensity measured at the second measurement point was taken as the principal light intensity. The diffraction efficiency was calculated from these measurement values using the above Formula (3). The results are shown in FIG. 27. FIG. 27 is a graph showing the calculated diffraction efficiency values of the PB lens of Comparative Example 1 and the measured diffraction efficiency values of the PB lens of Reference Example 1.

As shown in FIG. 27, the PB lens of Reference Example 1 exhibited a diffraction efficiency of 83% at a wavelength of 445 nm, a diffraction efficiency of 100% at a wavelength of 532 nm, and a diffraction efficiency of 94% at a wavelength of 632 nm. Comparison of these results with the calculation results in Comparative Example 1 shows that the measured diffraction efficiency values matched the calculation results. This confirmed that, as per the theory, the phase difference of the RM layer affects the diffraction efficiency. Thus, any half-wave plate with a broadband RM layer was found to achieve a PB lens having broadband diffraction efficiency.

### Example 1

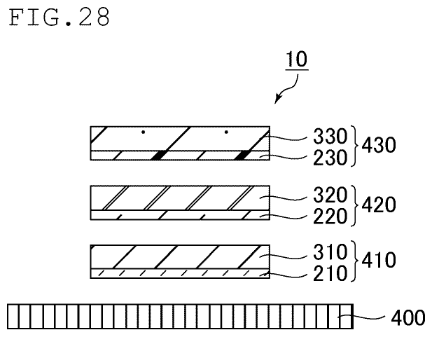

FIG. 28 is a schematic cross-sectional view of an optical element of Example 1. Example 1 relates to a PB lens corresponding to the optical element 10 of Embodiment 2. As shown in FIG. 28, an optical element 10 of Example 1 included, in the following order: a circular polarizer 400; a first phase difference plate 410; a second phase difference plate 420; and a third phase difference plate 430. The first phase difference plate 410 included, in order from the circular polarizer 400 side, a first alignment film 210 and a first optically anisotropic layer 310. The second phase difference plate 420 included, in order from the circular polarizer 400 side, a second alignment film 220 and a second optically anisotropic layer 320. The third phase difference plate 430 included, in order from the circular polarizer 400 side, a third alignment film 230 and a third optically anisotropic layer 330.

The azimuthal angle of the slow axis of the first phase difference plate 410 (i.e., first optically anisotropic layer 310) was 0° and the phase difference of the first phase difference plate 410 was λ/4. The azimuthal angle of the slow axis of the second phase difference plate 420 (i.e., second optically anisotropic layer 320) was 450 and the phase difference of the second phase difference plate 420 was λ/2. The azimuthal angle of the slow axis of the third phase difference plate 430 (i.e., third optically anisotropic layer 330) was 0° and the phase difference of the third phase difference plate 430 was λ/4. Since the alignment film does not contribute to the slow axis and phase difference of the phase difference plate, the azimuthal angle of the slow axis of the phase difference plate and the phase difference of the phase difference plate are respectively the same as the azimuthal angle of the slow axis of the optically anisotropic layer in the phase difference plate and the phase difference of the optically anisotropic layer.

In Example 1, the diffraction efficiency of the laminate of three RM layers was simulated. The design value of each RM layer was determined using the azimuthal angle of the slow axis and the phase difference provided to light with a wavelength of 550 nm.

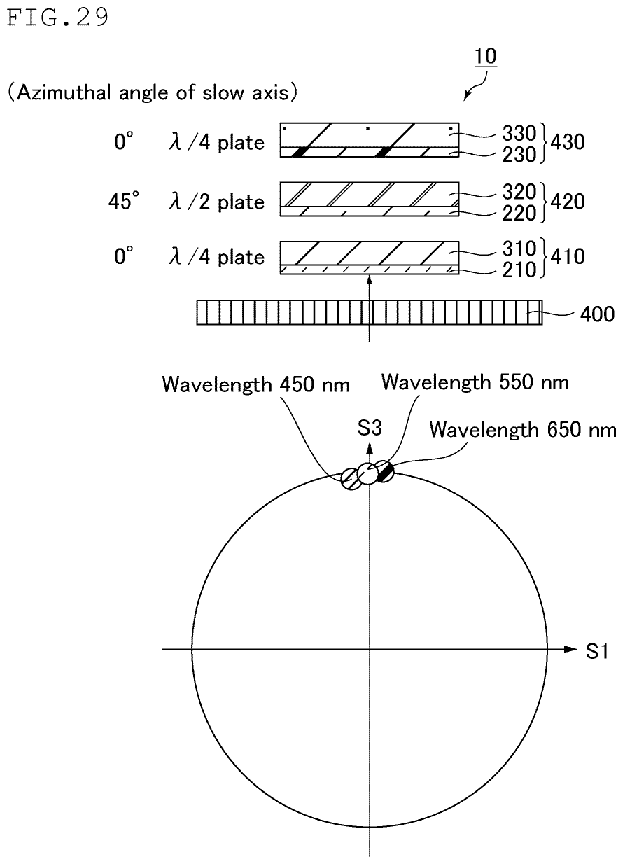

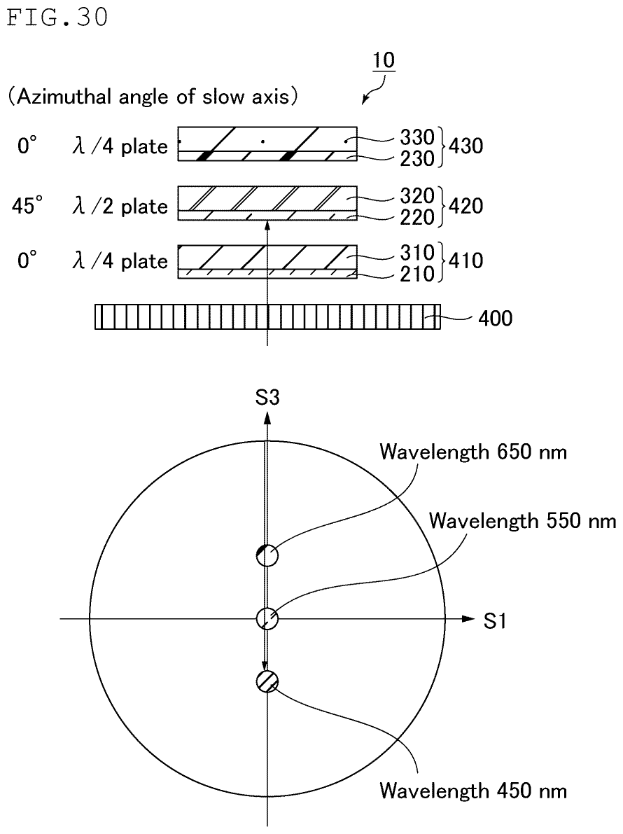

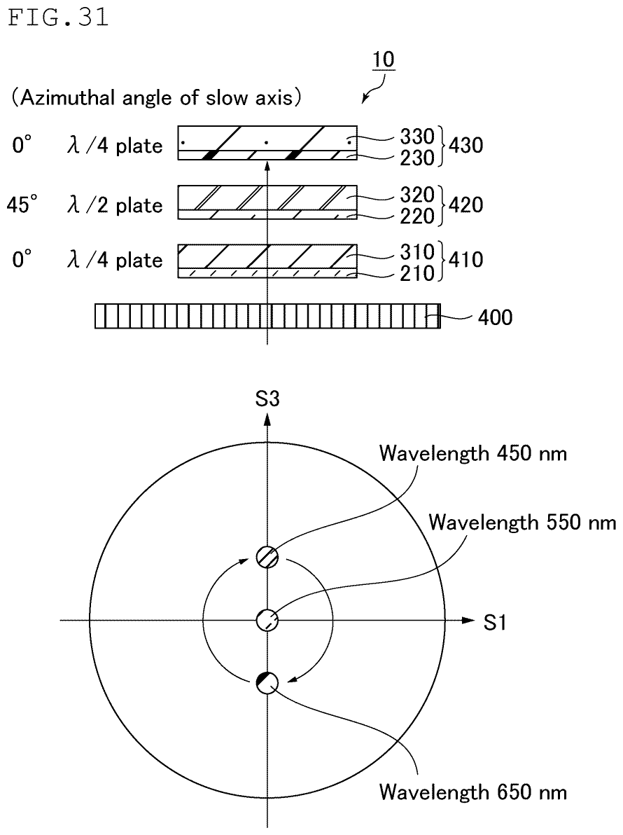

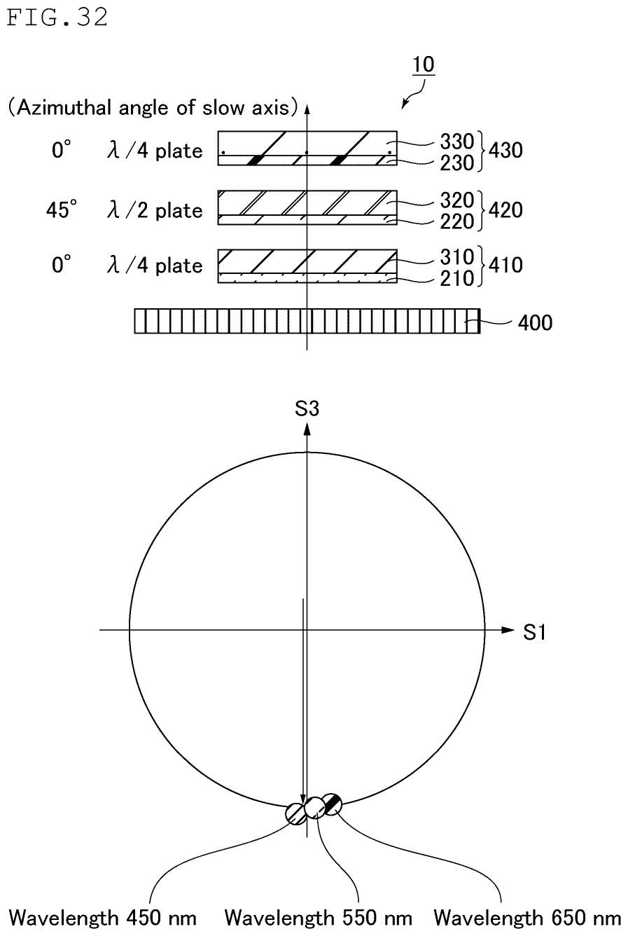

FIG. 29 is a view showing on the Poincare sphere the polarization state of light having passed through a circular polarizer in the optical element of Example 1. FIG. 30 is a view showing on the Poincare sphere the polarization state of light having passed through a first phase difference plate in the optical element of Example 1. FIG. 31 is a view showing on the Poincare sphere the polarization state of light having passed through a second phase difference plate in the optical element of Example 1. FIG. 32 is a view showing on the Poincare sphere the polarization state of light having passed through a third phase difference plate in the optical element of Example 1.

As shown in FIG. 29 to FIG. 32, the three phase difference plates (i.e., first phase difference plate 410, second phase difference plate 420, and third phase difference plate 430) reverse the handedness of the visible light (wavelength: 450 nm to 650 nm) converted to circularly polarized light through the circular polarizer. FIG. 29 to FIG. 32 show changes in polarization state by the phase difference plates on the Poincare sphere (S1-S3 plane).

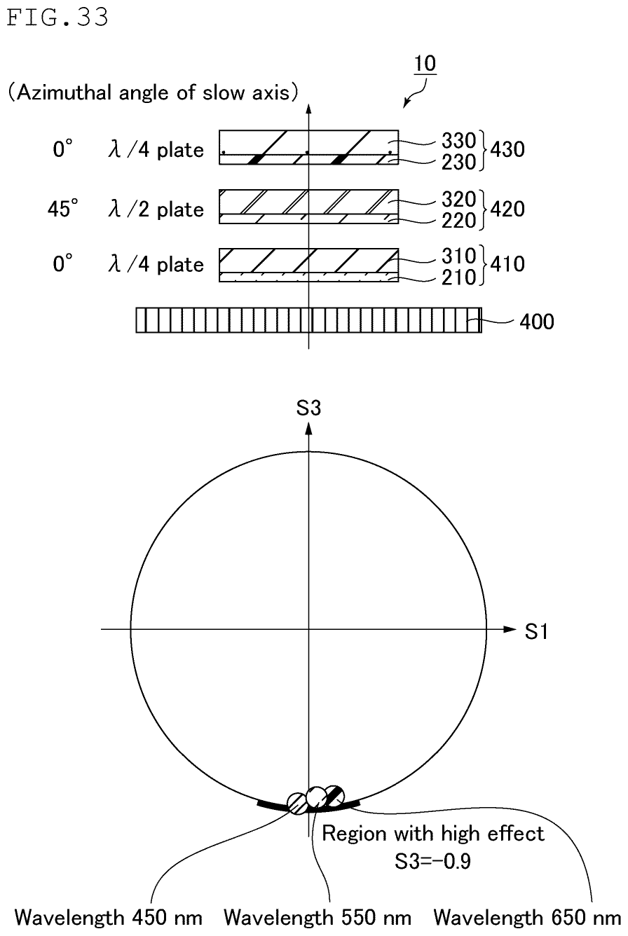

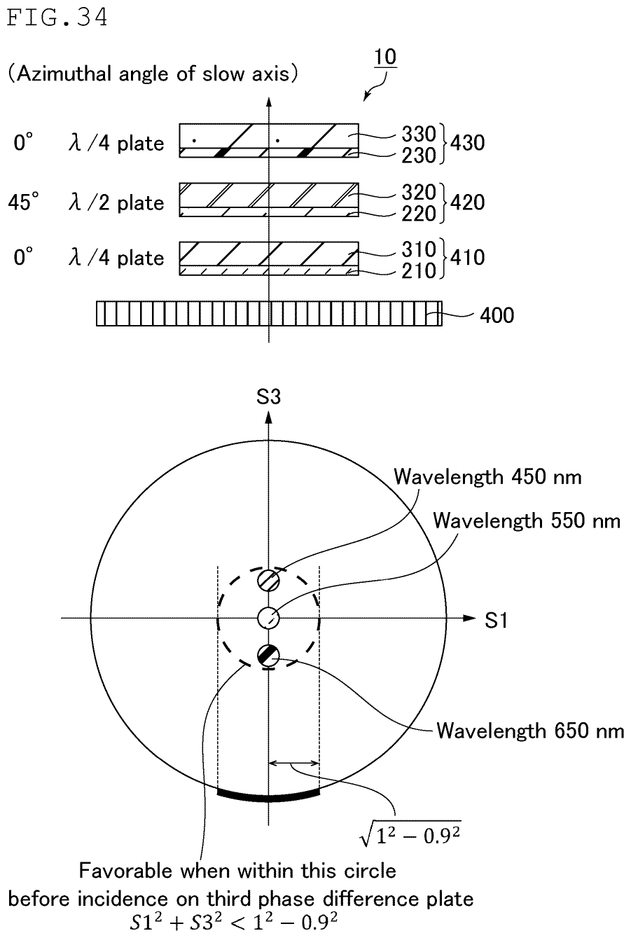

FIG. 33 is a view showing Formula 4 obtained using the optical element of Example 1. FIG. 33 shows the target values after the lights pass through all the phase difference plates. FIG. 34 is a view showing Formula 5 obtained using the optical element of Example 1. FIG. 34 shows the desirable polarization states before the lights pass through the third phase difference plate.

In order to achieve a broadband PB lens, as shown in FIG. 33, the polarization states after the lights have passed through the third phase difference plate 430 preferably satisfy the following Formula 4.

$$S 3 < - 0.9 \qquad ( Formula 4 )$$

In order to satisfy the above Formula 4, as shown in FIG. 34, the polarization states before the lights pass through the third phase difference plate 430 preferably satisfy the following Formula 5.

$$( S {1}^{2} + S {3}^{2} ) < {1}^{2} - {0.9}^{2} \qquad ( Formula 5 )$$

The conditions for satisfying the above Formula 5 can be expressed by the following Formula 6 wherein And represents the phase difference of the first optically anisotropic layer 310 in the first phase difference plate 410.

$$cos ( Δ nd / λ * 2 π ) < {( 1 - {0.9}^{2} )}^{( 1 / 2 )} \qquad ( Formula 6 )$$

In the above Formula 6, A represents a wavelength. In order for the inequality of the above Formula 6 to hold within the wavelength range of 450 nm to 650 nm, And is preferably 120 nm or more and 150 nm or less for light having a wavelength of 550 nm. The wavelength dispersion of each RM layer was assumed to be flat wavelength dispersion or positive wavelength dispersion.

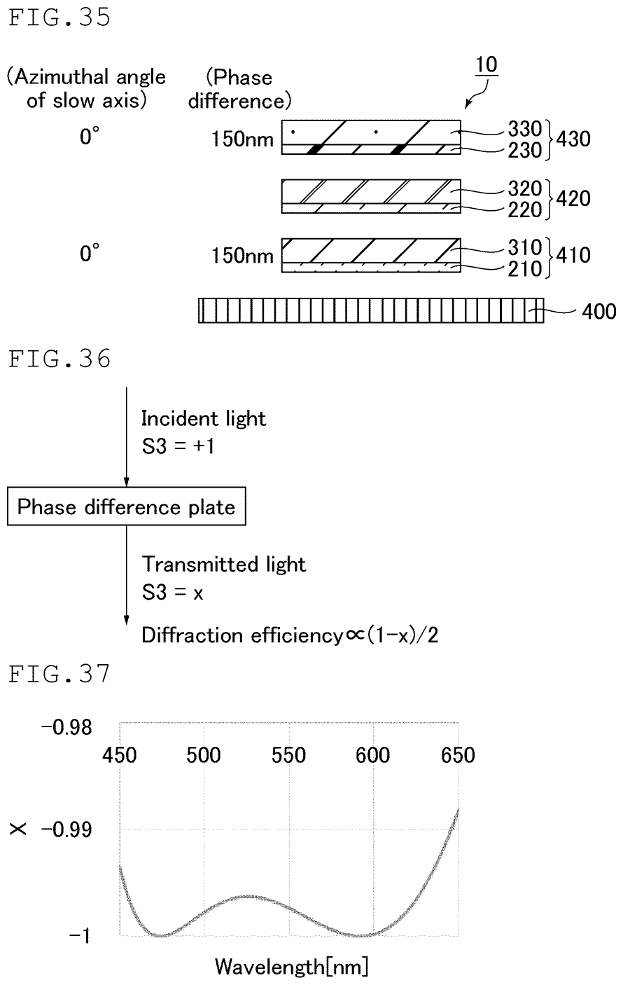

FIG. 35 is a schematic cross-sectional view of a structure in the case where in the optical element of Example 1, the phase differences of the first optically anisotropic layer and the third optically anisotropic layer are set to 150 nm. In Example 1, as shown in FIG. 35, the azimuthal angle of the slow axis of the second optically anisotropic layer 320 and the phase difference of the second optically anisotropic layer 320 with which broadband favorable diffraction efficiency can be obtained were examined for a case where the phase differences provided by the first optically anisotropic layer 310 and the third optically anisotropic layer 330 to light with a wavelength of 550 nm were set to 150 nm.

### <Calculation of Diffraction Efficiency>

FIG. 36 is a view illustrating the method of calculating diffraction efficiency. The diffraction efficiency of a PB lens using a phase difference plate other than an A-plate can be calculated as shown in FIG. 36. In other words, when S3 of transmitted light derived from circularly polarized light with S3=+1 incident on the phase difference plate is denoted as x, the diffraction efficiency is proportional to “(1−x)/2”.

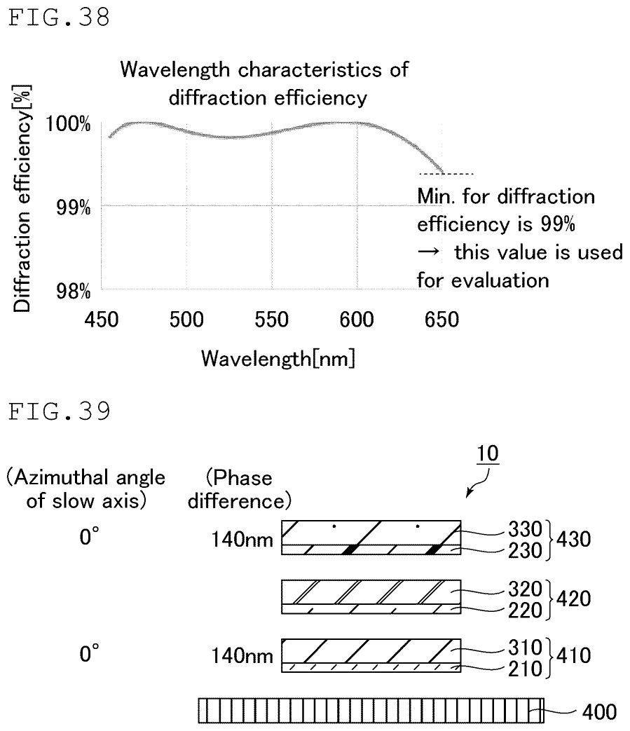

In the present example, the x value was calculated with an LCD master. The results are shown in FIG. 37. The x value was used to determine the wavelength characteristics of the diffraction efficiency. The results are shown in FIG. 38. FIG. 37 is a graph showing S3(x) of transmitted light versus wavelength of circularly polarized light with S3=+1 incident on the optical element of Example 1. FIG. 38 is a graph showing diffraction efficiency versus wavelength of circularly polarized light with S3=+1 incident on the optical element of Example 1. FIG. 37 and FIG. 38 respectively show the x and diffraction efficiency when the azimuthal angle of the slow axis of the second optically anisotropic layer 320 is 45° and the phase difference provided to light having a wavelength of 550 nm is 230 nm.

The diffraction efficiency was similarly determined for cases where the phase difference provided by the second optically anisotropic layer 320 to light having a wavelength of 550 nm and the azimuthal angle of the slow axis were changed. The calculation results are shown in the following Table 1. Table 1 shows, as shown in FIG. 38, only the lowest diffraction efficiency values among the values in the visible spectrum (450 nm to 650 nm). The lowest diffraction efficiency values were used for evaluation.

In Table 1, the diffraction efficiency values with a high effect are surrounded by the dashed line, and the those with a higher effect are surrounded by the heavy line. Usually, a diffraction efficiency lower than 80% causes ghost images to be noticeable, leading to display defects. Thus, the diffraction efficiency needs to be at least 80%. For higher-performance PB lenses, the diffraction efficiency is preferably 90% or higher, more preferably 95% or higher. In addition, production of PB lenses can more or less causes variation in phase difference and axis direction due to production errors. For these reasons, the design values regarded as high diffraction efficiency values and having a high tolerance for variation are surrounded as the effective ranges by the dashed line and heavy line in Table 1.

Table 1 shows that a high effect was successfully achieved when the azimuthal angle of the slow axis of the second optically anisotropic layer 320 was greater than 35° and smaller than 50° and the phase difference provided by the second optically anisotropic layer 320 to light having a wavelength of 550 nm was more than 150 nm and less than 350 nm. In addition, Table 1 shows that a higher effect was successfully achieved when the azimuthal angle of the slow axis of the second optically anisotropic layer 320 was greater than 35° and smaller than 50° and the phase difference provided by the second optically anisotropic layer 320 to light having a wavelength of 550 nm was more than 210 nm and less than 290 nm.

### Example 2

FIG. 39 is a schematic cross-sectional view of an optical element of Example 2. The diffraction efficiency of the optical element of Example 2 shown in FIG. 39 was calculated in a similar manner to that in Example 1. The results are shown in Table 2. The optical element 10 of Example 2 had a configuration similar to that in Example 1, except that the phase differences provided by the first optically anisotropic layer 310 and the third optically anisotropic layer 330 to light having a wavelength of 550 nm were 140 nm.

Table 2 shows that a high effect was successfully achieved when the azimuthal angle of the slow axis of the second optically anisotropic layer 320 was greater than 35° and smaller than 50° and the phase difference provided by the second optically anisotropic layer 320 to light having a wavelength of 550 nm was more than 150 nm and less than 350 nm. In addition, Table 2 shows that a higher effect was successfully achieved when the azimuthal angle of the slow axis of the second optically anisotropic layer 320 was greater than 35° and smaller than 50° and the phase difference provided by the second optically anisotropic layer 320 to light having a wavelength of 550 nm was more than 210 nm and less than 290 nm.

### Example 3

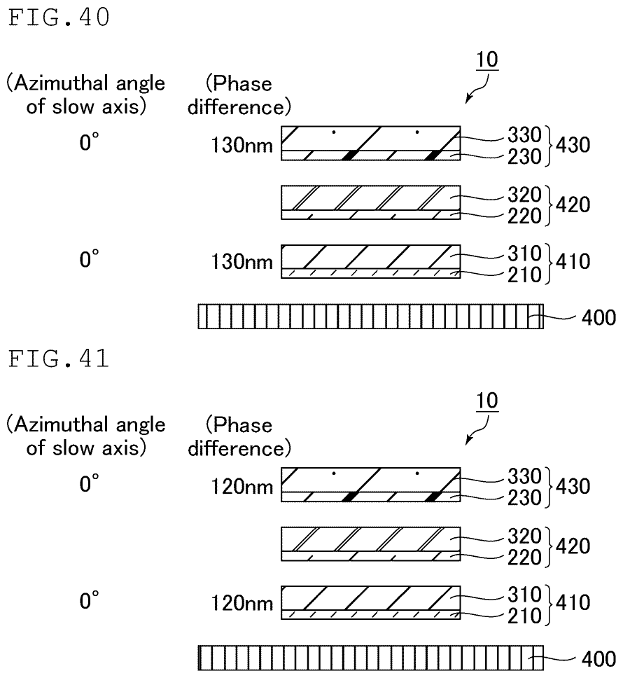

FIG. 40 is a schematic cross-sectional view of an optical element of Example 3. The diffraction efficiency of the optical element of Example 3 in FIG. 40 was calculated in a similar manner to that in Example 1. The results are shown in Table 3. The optical element 10 of Example 3 had a configuration similar to that in Example 1, except that the phase differences provided by the first optically anisotropic layer 310 and the third optically anisotropic layer 330 to light having a wavelength of 550 nm were 130 nm.

Table 3 shows that a high effect was successfully achieved when the azimuthal angle of the slow axis of the second optically anisotropic layer 320 was greater than 35° and smaller than 50° and the phase difference provided by the second optically anisotropic layer 320 to light having a wavelength of 550 nm was more than 150 nm and less than 350 nm. In addition, Table 3 shows that a higher effect was successfully achieved when the azimuthal angle of the slow axis of the second optically anisotropic layer 320 was greater than 35° and smaller than 50° and the phase difference provided by the second optically anisotropic layer 320 to light having a wavelength of 550 nm was more than 210 nm and less than 290 nm.

### Example 4

FIG. 41 is a schematic cross-sectional view of an optical element of Example 4. The diffraction efficiency of the optical element of Example 4 shown in FIG. 41 was calculated in a similar manner to that in Example 1. The results are shown in Table 4. The optical element 10 of Example 4 had a configuration similar to that in Example 1, except that the phase differences provided by the first optically anisotropic layer 310 and the third optically anisotropic layer 330 to light having a wavelength of 550 nm were 120 nm.

Table 4 shows that a high effect was successfully achieved when the azimuthal angle of the slow axis of the second optically anisotropic layer 320 was greater than 35° and smaller than 50° and the phase difference provided by the second optically anisotropic layer 320 to light having a wavelength of 550 nm was more than 150 nm and less than 350 nm. In addition, Table 4 shows that a higher effect was successfully achieved when the azimuthal angle of the slow axis of the second optically anisotropic layer 320 was greater than 35° and smaller than 50° and the phase difference provided by the second optically anisotropic layer 320 to light having a wavelength of 550 nm was more than 210 nm and less than 290 nm.

### Example 5

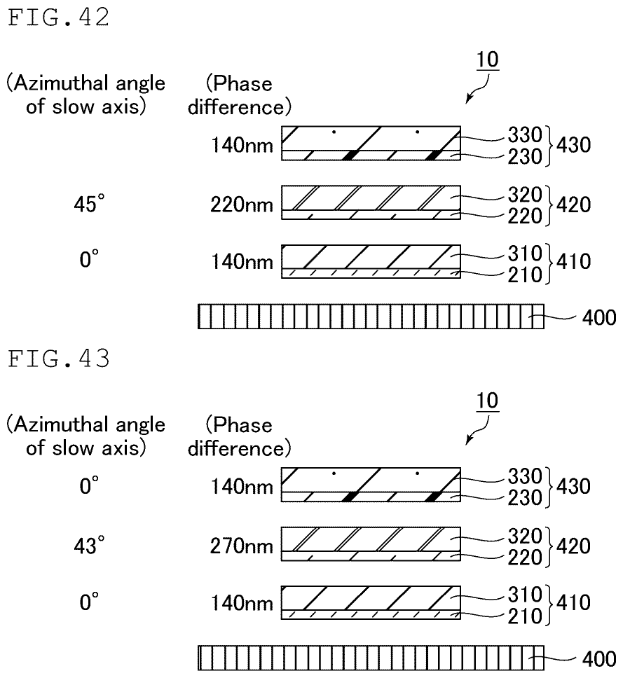

FIG. 42 is a schematic cross-sectional view of an optical element of Example 5. The diffraction efficiency of the optical element of Example 5 shown in FIG. 42 was calculated in a similar manner to that in Example 1. The results are shown in Table 5. In Example 5, the azimuthal angle of the slow axis of the first optically anisotropic layer 310 was set to 0°, the phase difference provided by the first optically anisotropic layer 310 to light having a wavelength of 550 nm was set to 140 nm, the azimuthal angle of the slow axis of the second optically anisotropic layer 320 was set to 45°, the phase difference provided by the second optically anisotropic layer 320 to light having a wavelength of 550 nm was set to 220 nm, and the phase difference provided by the third optically anisotropic layer 330 to light having a wavelength of 550 nm was set to 140 nm, and the azimuthal angle of the slow axis of the third optically anisotropic layer 330 was varied, so that the effect when the azimuthal angle of the slow axis of the first optically anisotropic layer 310 was not parallel to the azimuthal angle of the slow axis of the third optically anisotropic layer 330 was evaluated. The azimuthal angle of the slow axis of the third optically anisotropic layer 330 was varied within the range of −25° to 25°.

Table 5 shows that a high effect was successfully achieved when the azimuthal angle of the slow axis of the third optically anisotropic layer 330 was greater than −25° and smaller than 25°. In addition, Table 5 shows that a higher effect was successfully achieved when the azimuthal angle of the slow axis of the third optically anisotropic layer 330 was greater than −5° and smaller than 5°.

### Example 6

FIG. 43 is a schematic cross-sectional view of an optical element of Example 6. The optical element of Example 6 shown in FIG. 43 was produced and the validity of the simulation was confirmed. The method of producing the optical element was similar to that in Reference Example 1.

The diffraction efficiency of the optical element of Example 6 was calculated as shown below. First, AxoScan was used to measure a Mueller matrix. The Mueller matrix was used to calculate the polarization state (x in Example 1) of emission light derived from incident polarized light with S3=+1. The value to be compared with the measured value was calculated with an LCD master. The measured values and the calculated values are shown in the following Table 6.

TABLE 6

| | Measured | Calculated |
|---|---|---|
| | value | value |
| Wavelength at which diffraction efficiency | 450 nm | 450 nm |
| is minimum | | |
| S3 of transmitted light when light with | −0.975 | −0.975 |
| S3 = +1 is incident | | |
| Expected diffraction efficiency value | 99% | 99% |

As shown in Table 6, the measured values matched the calculated values. This shows that the calculated values in Examples 1 to 5 were reproduced in the actual measurement.

### Example 7

In Example 7, a PB lens corresponding to the optical element 10 of Embodiment 3 was used to verify that the focal length was successfully shortened by laminating PB lenses without any change in molecular rotation period.

The PB lens of Example 7 is obtainable by further forming a PB lens on a sample corresponding to the PB lens of Reference Example 1. The procedure of forming the PB lens is shown below.

A photoisomerizable photoalignment film was formed on an optically anisotropic layer of the PB lens produced in Reference Example 1 (alignment film formation step). The workpiece was irradiated with polarized UV lights with 100 mJ/cm² (365 nm) through four annular masks in each of which an opening alternated with a closed portion (alignment film exposure step). The masks were designed such that a region irradiated with multiple polarized UV lights alternated with a region not irradiated with multiple polarized UV lights. The polarization directions of PUV lights were set to 0°, −45°, −90°, and −135°.

After being irradiated with polarized UV lights, the workpiece was baked in a 160° C. oven for 20 minutes, and RMs were applied to the baked workpiece. The RMs were applied with a spin coater spinning at 1000 rpm to such a thickness that a phase difference provided to light with a wavelength of 550 nm would be about 270 nm. In other words, the RMs were applied such that the optically anisotropic layer 300 would provide a phase difference of λ/2.

The RM layer exhibited positive wavelength dispersion, ratios of Re (450 nm)/Re (550 nm)≈1.04, and Re (650 nm)/Re (550 nm)≈0.97. The applied RMs were cured with unpolarized UV with 200 mJ (365 nm) (optically anisotropic layer formation step), whereby the PB lens of Example 7 was obtained.

The focal length of the PB lens of Example 7 was measured in a similar manner to that in Reference Example 1, which resulted in 25 cm. Since the lens was produced using masks similar to those in Reference Example 1, the period taken for molecules to rotate 180° in the first layer was the same as that in the second layer. Thus, the above Formula A held.

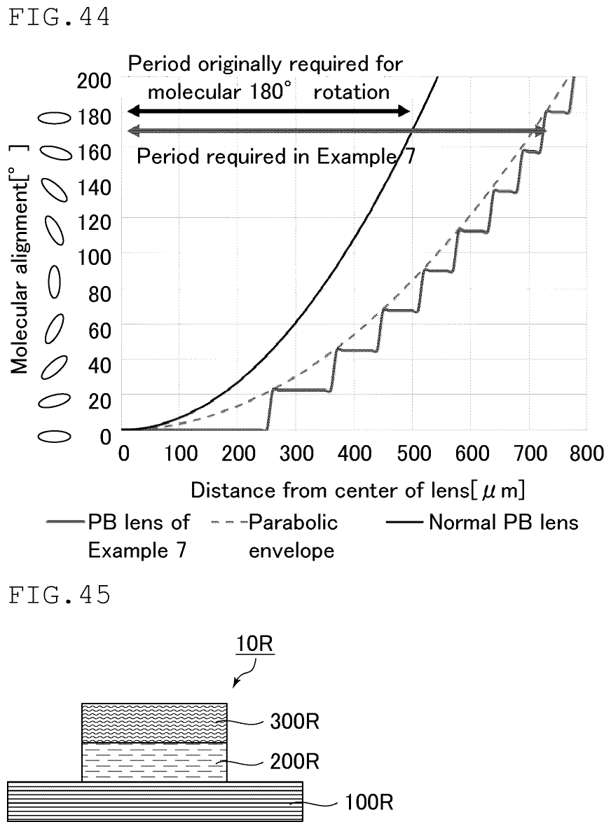

The above Formula 1, a general expression, is an equation, but is an inequality as shown in the above Formula A in the present example. This shows that, as shown in FIG. 44, the lens of Example 7 is a fixed focal lens even though the period taken for molecules to rotate 180° is long. A longer period lowers the mask alignment accuracy required for production, thus facilitating the production. As described above, in Example 7, the method of shortening the focal length without any change in molecular rotation period was shown and the method of alleviating the difficulty in production limited by the alignment accuracy was verified. Also, FIG. 44 shows that the first anisotropic molecules 311 and the second anisotropic molecules 321 have discrete molecular alignment patterns from the central portion toward the end portion of the optical element 10. FIG. 44 is a graph showing the relationship between the distance from the center of a lens and the molecular alignment in the optical element of Example 7.

### REFERENCE SIGNS LIST

10: optical element
10R: PB lens
20, 20R: mask set
20₁, 20₂, 20₃, 20₄, 20_{M}, 20ᵣ, 20ᵣ₋₁, 20ᵣ₋₂, 20R₁, 20R₂, 20R₃, 20R₄: mask
20A₁, 20A₂, 20A₃, 20A₄, 20Aᵣ, 20Aᵣ₋₁, 20Aᵣ₋₂, 20RA₁, 20RA₂, 20RA₃, 20RA₄: light-transmitting portion (opening)
20B₁, 20B₂, 20B₃, 20B₄, 20Bᵣ, 20Bᵣ₋₁, 20Bᵣ₋₂, 20RB₁, 20RB₂, 20RB₃, 20RB₄: light-blocking portion
30₁, 30₂, 30₃: region
100, 100R: supporting substrate
200, 200R, 210, 220, 230: alignment film
300, 300R, 310, 320, 330: optically anisotropic layer
301, 311, 321, 331: anisotropic molecule
400: circular polarizer
410, 420, 430: phase difference plate

What is claimed is:

1. An optical element comprising, in the following order:
a first alignment film;
a first optically anisotropic layer containing first anisotropic molecules;
a second alignment film; and
a second optically anisotropic layer containing second anisotropic molecules.

2. The optical element according to claim 1, further comprising:
a third alignment film disposed on a surface of the second optically anisotropic layer opposite to the second alignment film; and
a third optically anisotropic layer disposed on a surface of the third alignment film opposite to the second optically anisotropic layer and containing third anisotropic molecules.

3. The optical element according to claim 2,
wherein with an azimuthal angle of a slow axis of the first optically anisotropic layer being set at 0°,
an azimuthal angle of a slow axis of the second optically anisotropic layer is greater than 350 and smaller than 50°, and
an azimuthal angle of a slow axis of the third optically anisotropic layer is greater than −25° and smaller than 25°.

4. The optical element according to claim 3,
wherein a phase difference of the first optically anisotropic layer provided to light with a wavelength of 550 nm is 120 nm or more and 150 nm or less,
a phase difference of the second optically anisotropic layer provided to light with a wavelength of 550 nm is 150 nm or more and 350 nm or less, and
a phase difference of the third optically anisotropic layer provided to light with a wavelength of 550 nm is 120 nm or more and 150 nm or less.

5. The optical element according to claim 2,
wherein with an azimuthal angle of a slow axis of the first optically anisotropic layer being set at 0°,
an azimuthal angle of a slow axis of the second optically anisotropic layer is greater than 35° and smaller than 50°, and
an azimuthal angle of a slow axis of the third optically anisotropic layer is greater than −5° and smaller than 5°.

6. The optical element according to claim 5,
wherein a phase difference of the first optically anisotropic layer provided to light with a wavelength of 550 nm is 120 nm or more and 150 nm or less,
a phase difference of the second optically anisotropic layer provided to light with a wavelength of 550 nm is 210 nm or more and 290 nm or less, and
a phase difference of the third optically anisotropic layer provided to light with a wavelength of 550 nm is 120 nm or more and 150 nm or less.

7. The optical element according to claim 1,
wherein in a plan view,
alignment directions of the first anisotropic molecules and alignment directions of the second anisotropic molecules each rotate in a plane from a central portion to an end portion of the optical element, and
a rotation direction of the first anisotropic molecules is opposite to a rotation direction of the second anisotropic molecules.

8. The optical element according to claim 7, which satisfies the following Formula A:
$$Molecular alignment [ ° ] < 90 / ( Wavelength [ m ] ) / ( Focal length [ m ] ) * {( Distance from center of lens [ m ] )}^{2} \qquad ( Formula A )$$
where the molecular alignment represents an azimuthal angle of a molecular alignment of each of the first anisotropic molecules or each of the second anisotropic molecules; the wavelength represents a wavelength of incident light; the focal length represents a focal length of the optical element; and the distance from a center of a lens represents a distance from a center of the optical element to the first anisotropic molecule or the second anisotropic molecule.

9. The optical element according to claim 1,
wherein from a central portion toward an end portion of the optical element, the first anisotropic molecule and the second anisotropic molecule each have a discrete molecular alignment pattern.
